(19) United States
(12) Patent Application Publication
(10) Pub. No.: US 2013/0122884 A1
(43) Pub. Date: May 16, 2013

(54) CONTROL APPARATUS, COMMUNICATION SYSTEM AND CONTROL METHOD

(71) Applicant: FUJITSU LIMITED, Kasawasaki-shi (JP)

(72) Inventor: Naoyuki Saito, Yokosuka (JP)

(73) Assignee: FUJITSU LIMITED, Kawasaki-shi (JP)

(21) Appl. No.: 13/625,964

(22) Filed: Sep. 25, 2012

(30) Foreign Application Priority Data
Nov. 16, 2011 (JP) 2011-251102

(51) Int. Cl. H04W 24/00

(52) U.S. Cl. 455/418

(57) ABSTRACT

A control apparatus includes a memory, and a processor that executes a procedure stored in the memory, the procedure including, comparing a first index value with a second index value, the first index value indicating a magnitude of a difference between a coverage in an area to which a communication service is provided by a radio base station to be controlled and a first target value, the second index value indicating a magnitude of a difference between a capacity of the communication service in the area and a second target value, and controlling an operation state of the radio base station that varies at least one of the coverage and the capacity so as to decrease a difference between the first and second index value when the result of the comparing indicates that the magnitude of the difference between the first and second index value exceeds a given value.

### CROSS-REFERENCE TO RELATED APPLICATION

This application is based upon and claims the benefit of priority of the prior Japanese Patent Application No. 2011-251102, filed on Nov. 16, 2011, the entire contents of which are incorporated herein by reference.

### FIELD

The embodiments discussed herein are related to a control apparatus, a communication system, and a control method.

### BACKGROUND

Self Organizing Networks (SON) are known, which automate installation and operation of base stations in such as radio communication systems (for example, Japanese Laid-open Patent Publication No. 2009-130728, International Publication Pamphlet No. WO 2008/065933, and “3GPP TS 32.521 V10.1.0 (2010-12).” The SON includes categories including Self-Configuration and Self-Optimization. For example, operation, monitoring, and control of networks is known, which concerns autonomous control from building of radio areas to operation and optimization of networks and which performs Coverage and Capacity Optimization (CCO).

### SUMMARY

According to an aspect of the invention, a control apparatus includes a memory, and a processor that executes a procedure stored in the memory, the procedure including, comparing a first index value with a second index value, the first index value indicating a magnitude of a difference between a coverage in an area to which a communication service is provided by a radio base station to be controlled and a first target value, the second index value indicating a magnitude of a difference between a capacity of the communication service in the area and a second target value, and controlling an operation state of the radio base station that varies at least one of the coverage and the capacity so as to decrease a difference between the first index value and the second index value when the result of the comparing indicates that the magnitude of the difference between the first index value and the second index value exceeds a given value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A illustrates a first example of control of a radio base station by a control apparatus according to a first embodiment;

FIG. 1B illustrates a second example of control of the radio base station by the control apparatus according to the first embodiment;

FIG. 1C illustrates a third example of control of the radio base station by the control apparatus according to the first embodiment;

FIG. 1D illustrates a fourth example of control of the radio base station by the control apparatus according to the first embodiment;

FIG. 1E illustrates a fifth example of control of the radio base station by the control apparatus according to the first embodiment;

FIG. 1F illustrates a sixth example of control of the radio base station by the control apparatus according to the first embodiment;

FIG. 2 illustrates a first exemplary communication system;

FIG. 3 illustrates a second exemplary communication system;

FIG. 4 is a flow chart illustrating an example of a control process by the control apparatus;

FIG. 5 is a flow chart illustrating an example of a process of deriving a first evaluation index value by the control apparatus;

FIG. 6 is a flow chart illustrating an example of a process of deriving a second evaluation index value by the control apparatus;

FIG. 7 illustrates an example of the hardware configuration of a radio network monitoring control apparatus;

FIG. 8 illustrates an example of the hardware configuration of a radio base station;

FIG. 9 illustrates exemplary functional blocks in the radio base station;

FIG. 10 is a flow chart illustrating an example of a process of deriving the second evaluation index value by a control apparatus according to a second embodiment;

FIG. 11 is a table illustrating examples of KPIs in setting of targets concerning service conditions and calculation of the current values; and

FIG. 12 is a table illustrating examples of KPIs in setting of targets concerning sensible performance conditions and calculation of the current values.

### DESCRIPTION OF EMBODIMENTS

Control apparatuses, communication systems, and control methods according to embodiments will herein be described in detail with reference to the attached drawings.

While inventing the present embodiments, observations were made regarding a related art. Such observations include the following, for example.

In CCO of a radio communication system of the related art, for example, collection and statistical processing of radio propagation environment (area coverage and radio signal quality) of radio areas are performed to update radio operation parameters in radio base stations, thereby making an attempt to improve, for example, dead zones and points where interference increases (area quality).

In addition, independent of the improvement of the area quality, priority of user allocation and Quality of Service (QoS) are controlled so as to meet service conditions for users (including user sensible conditions) in given radio propagation environments. The control of the priority of user allocation and the QoS is performed by, for example, wireless packet schedulers in the radio base stations. This attempts to improve the throughput performance of each user and the throughput (capacity) of the entire area. Running of radio apparatuses is stopped in order to achieve electric power saving during the operation in spots and areas where no user exists, for example, at night.

However, the improvement of the coverage is performed separately from the improvement of a capacity in the above technologies in related art, an imbalance occurs between the degree of achievement of the coverage relative to its target value and the degree of achievement of the capacity relative to its target value. Accordingly, over quality in radio areas and over processing in base stations can occur to reduce the operational efficiency of working equipment, power, and so on.

### First Embodiment

### Examples of Control of Radio Base Station by Control Apparatus

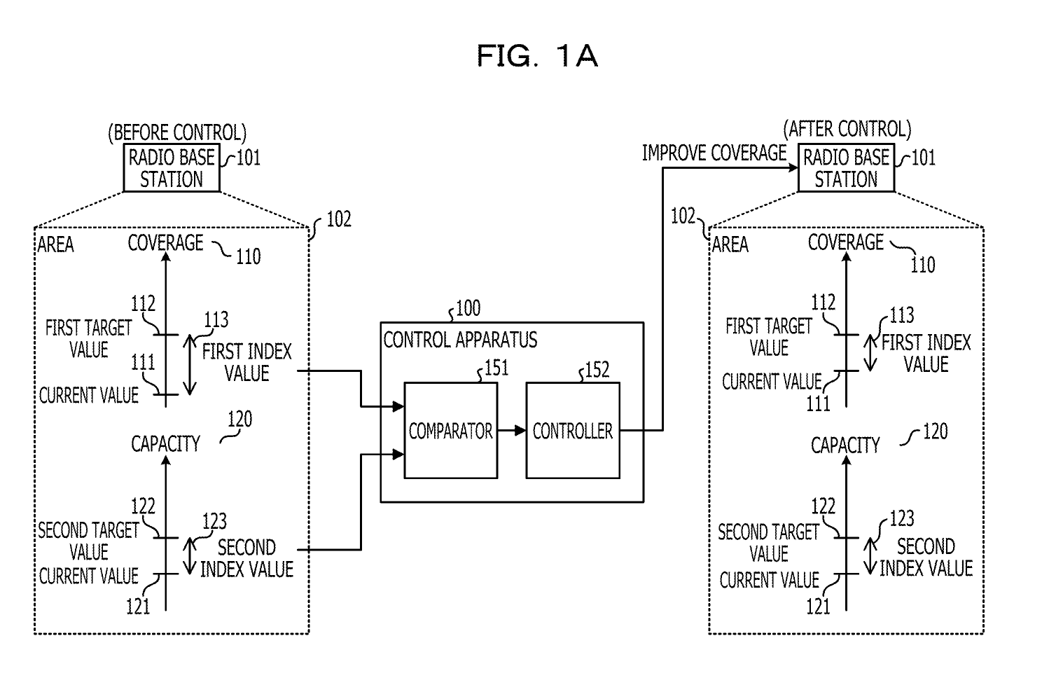

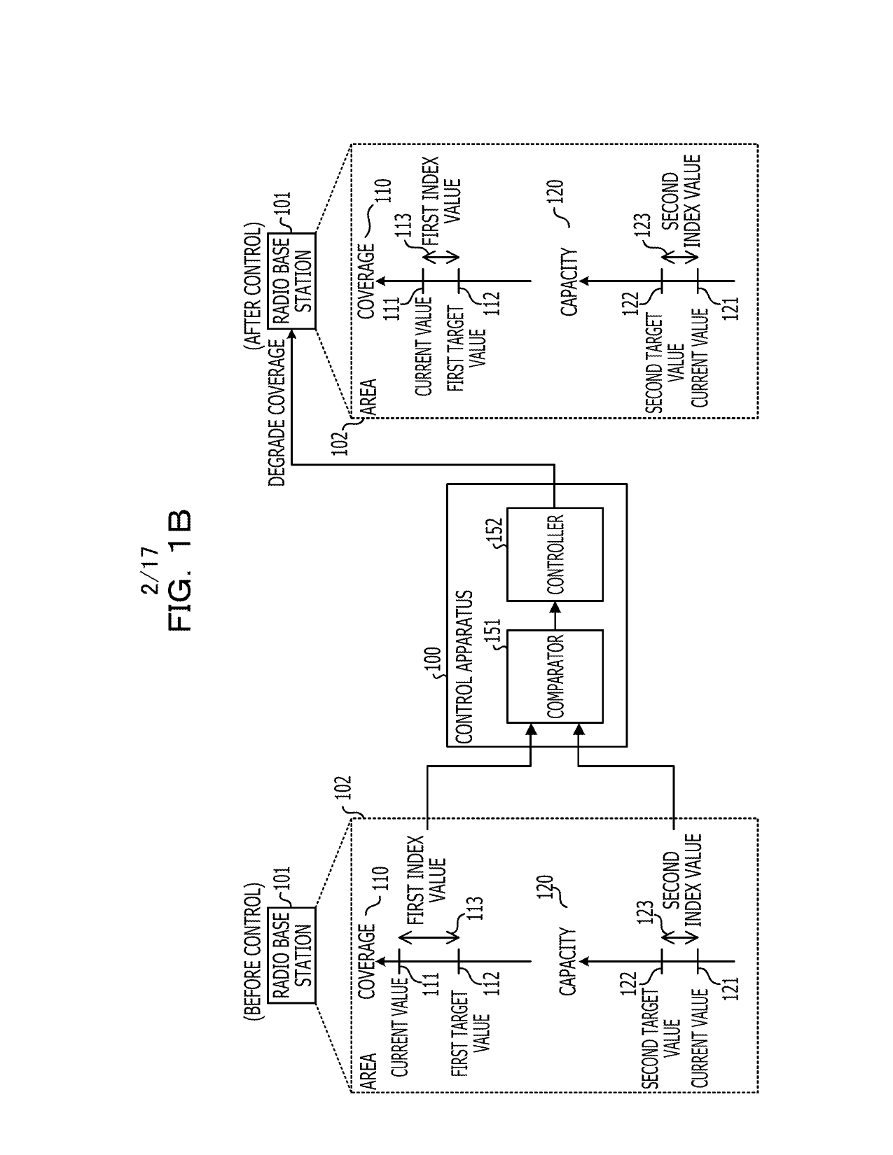

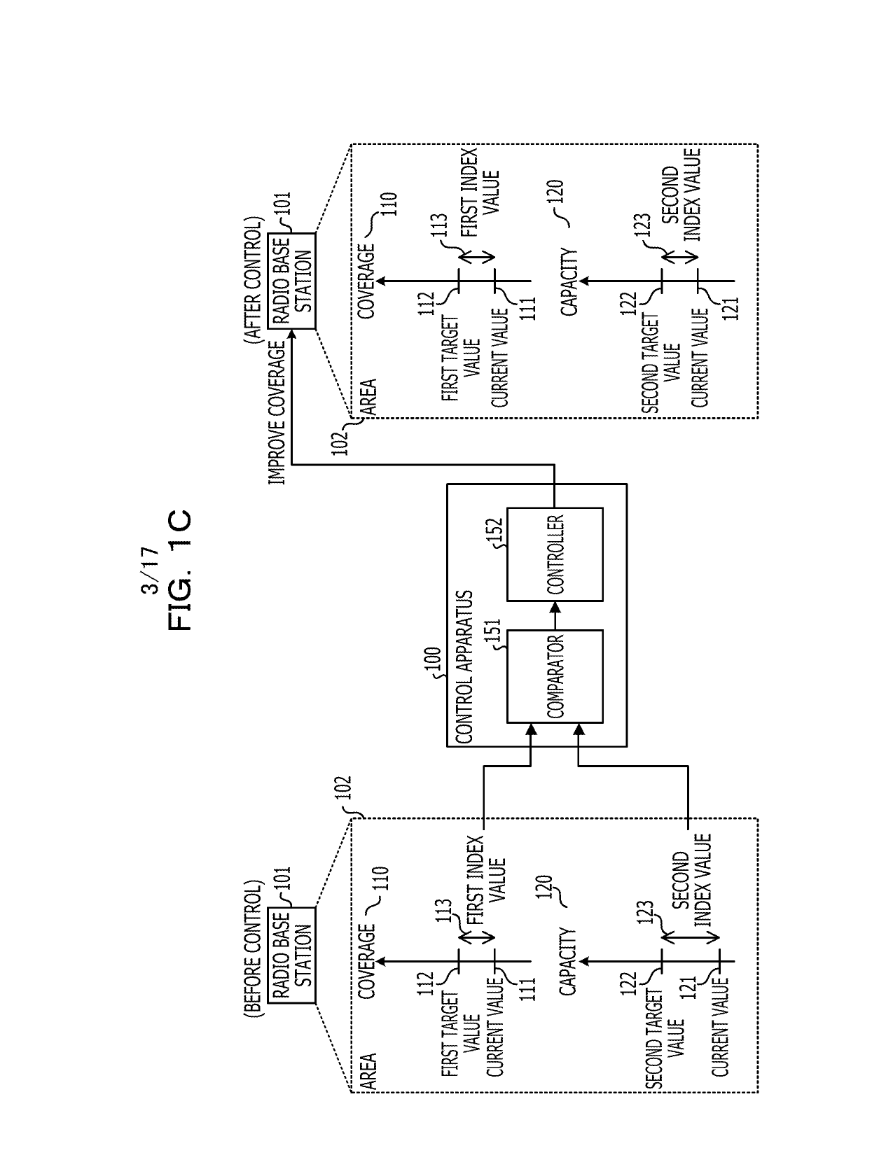

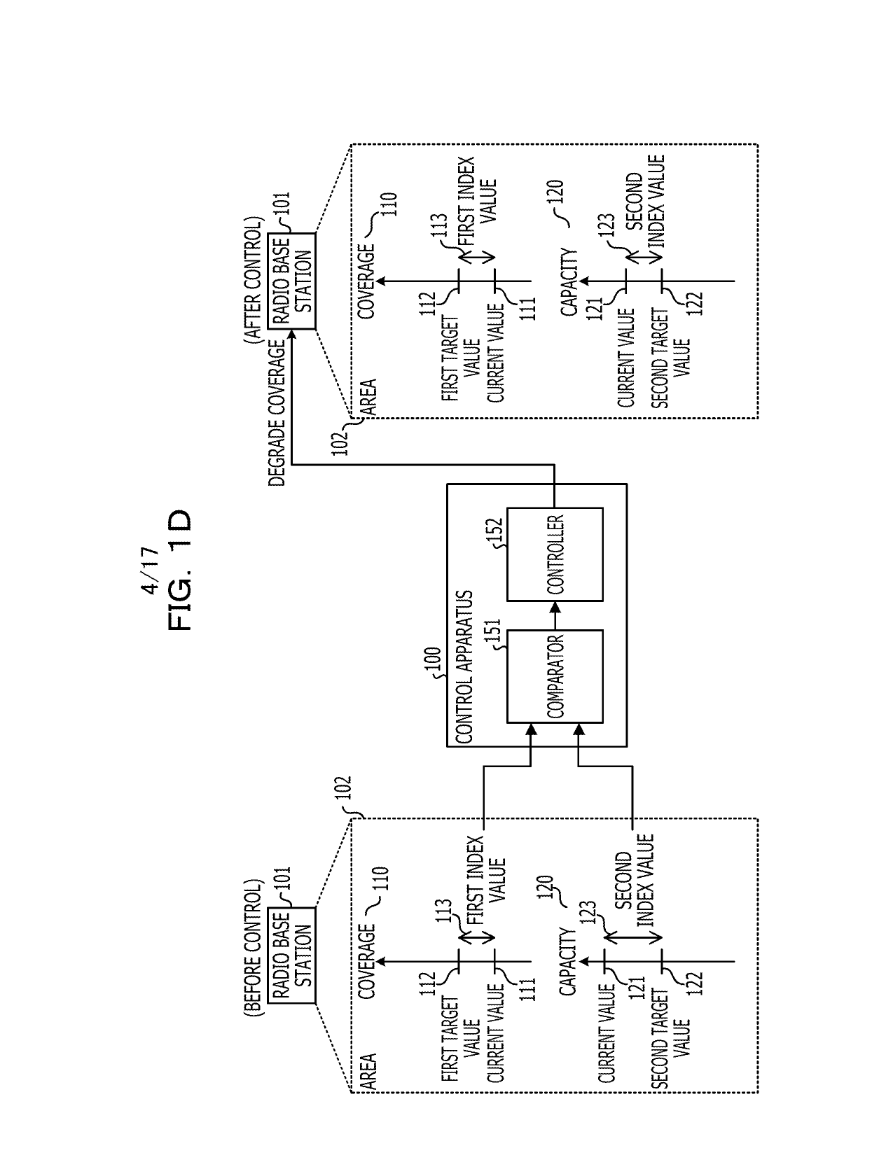

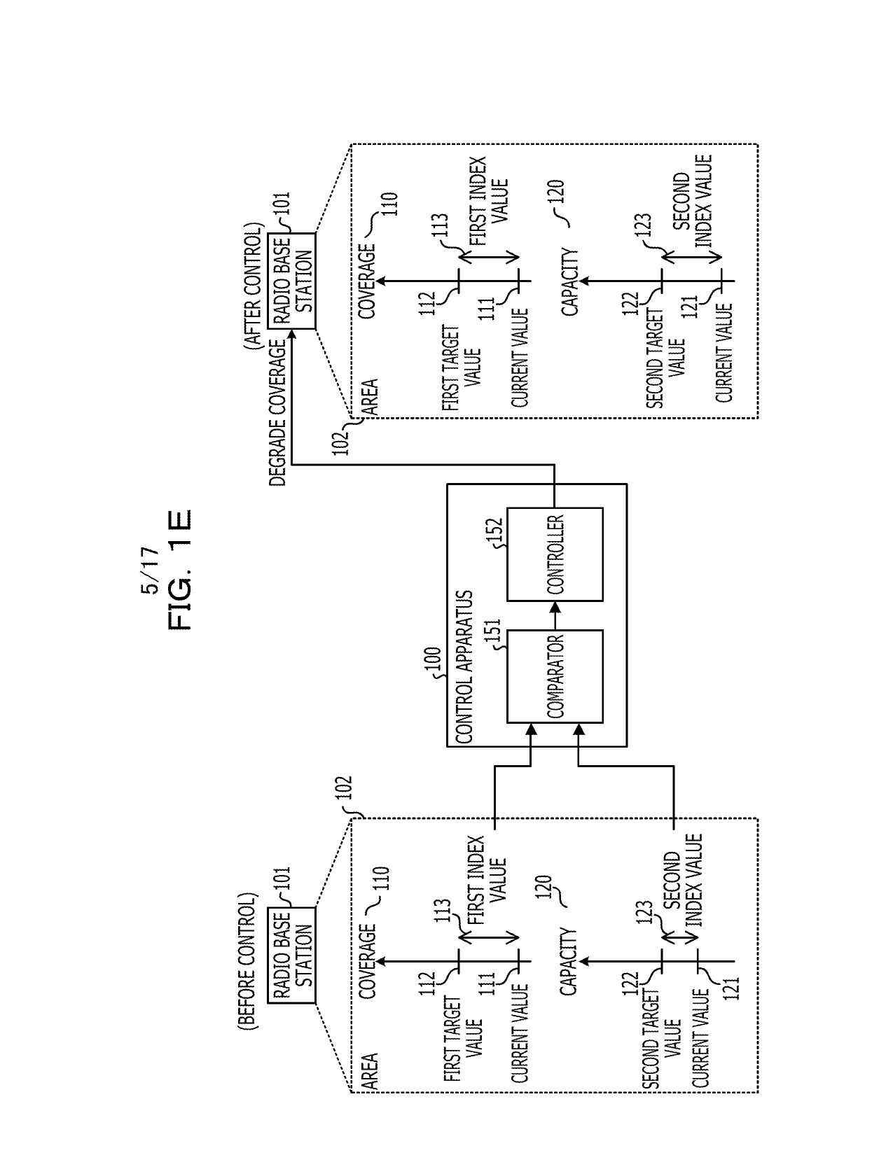

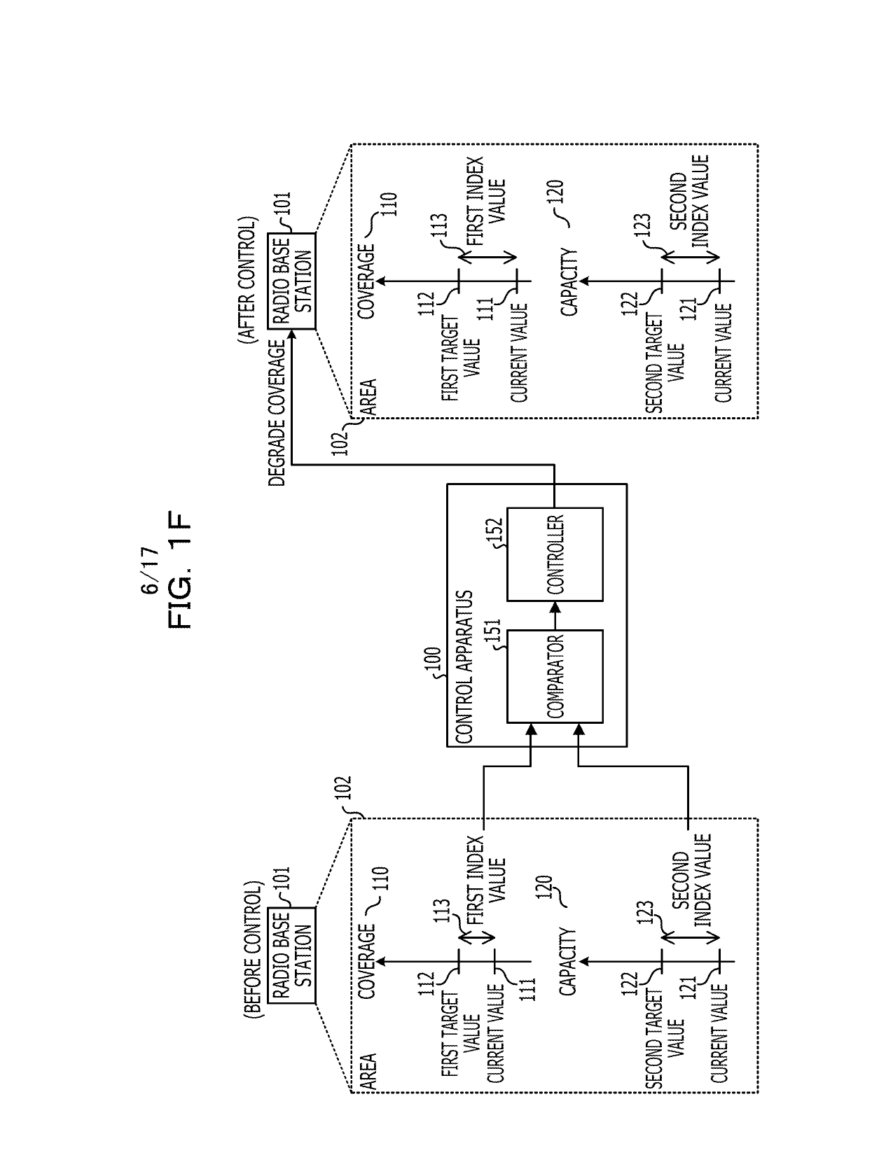

FIG. 1A illustrates a first example of control of a radio base station by a control apparatus according to a first embodiment. A control apparatus 100 according to the first embodiment controls the operation state of a radio base station 101. One radio base station or multiple radio base stations may be controlled by the control apparatus 100.

The operation state of the radio base station 101 controlled by the control apparatus 100 is represented by operation parameters including the orientation of an antenna of the radio base station 101, the power used in the radio base station 101, turning on-off of frequency bands, the number of the working radio base stations 101, and the processing capacity (resource) of baseband signals. An area 102 indicates a range to which a communication service is provided by the radio base station 101.

### Coverage

A coverage 110 is an index value indicating the radio quality (ease of connection of radio communication) in the area 102. The coverage 110 may include not only the coverage of the radio base station 101 to be controlled by the control apparatus 100 but also the coverages of other radio base stations. A current value 111 indicates the current value of the coverage 110. For example, the control apparatus 100 is capable of acquiring information on the radio quality measured in the radio base station 101 or measured in a terminal apparatus establishing the radio communication with the radio base station 101 to derive the current value 111 based on the acquired information.

The information on the radio quality indicates, for example, the strength of radio propagation, such as reference signal received power (RSRP), and radio signal quality, such as signal to interference and noise ratio (SINR).

A first target value 112 is a certain target value of the coverage 110. A first index value 113 indicates the magnitude of the difference between the first target value 112 and the current value 111 of the coverage 110. The first index value 113 may increase with the increasing difference between the first target value 112 and the current value 111 or may decrease with the increasing difference between the first target value 112 and the current value 111.

For example, the control apparatus 100 is capable of calculating the absolute value of the difference between the current value 111 and the first target value 112 to acquire the first index value 113. However, the first index value 113 is not limited to the absolute value of the difference between the current value 111 and the first target value 112. For example, the control apparatus 100 may calculate the ratio of the current value 111 with respect to the first target value 112, etc. to acquire the first index value 113.

### Capacity

A capacity 120 is an index value indicating the throughput of a communication service in the area 102. A current value 121 indicates the current value of the capacity 120. For example, the control apparatus 100 is capable of acquiring information on the number of users (terminals) or the amount of traffic in the area 102 to calculate the current value 121 based on the acquired information.

A second target value 122 is a certain target value of the capacity 120. The second target value 122 may be equal to the first target value 112 of the coverage 110 or may be different from the first target value 112 thereof. A second index value 123 indicates the magnitude of the difference between the second target value 122 and the current value 121 of the capacity 120. The second index value 123 may increase with the increasing difference between the second target value 122 and the current value 121 or may decrease with the increasing difference between the second target value 122 and the current value 121.

For example, the control apparatus 100 is capable of calculating the absolute value of the difference between the current value 121 and the second target value 122 to acquire the second index value 123. However, the second index value 123 is not limited to the absolute value of the difference between the current value 121 and the second target value 122. For example, the control apparatus 100 may calculate the ratio of the current value 121 with respect to the second target value 122, etc. to acquire the second index value 123.

### Control Apparatus

The control apparatus 100 includes a comparator 151 and a controller 152. The comparator 151 compares the first index value 113 with the second index value 123. For example, the comparator 151 performs subtraction between the first index value 113 and the second index value 123. The comparator 151 supplies the result of the comparison between the first index value 113 and the second index value 123 to the controller 152.

The controller 152 controls the operation state of the radio base station 101 that varies at least one of the coverage 110 and the capacity 120 based on the result of the comparison supplied from the comparator 151. Specifically, if the magnitude of the difference between the first index value 113 and the second index value 123 exceeds a given allowable value, the controller 152 controls the operation state of the radio base station 101 so as to decrease the difference between the first index value 113 and the second index value 123.

In the example in FIG. 1A, it is assumed that the magnitude of the difference between the first index value 113 and the second index value 123 exceeds the allowable value. In addition, in the example in FIG. 1A, the magnitude of the difference indicated by the first index value 113 is greater than the magnitude of the difference indicated by the second index value 123. In this case, the controller 152 controls the operation state of the radio base station 101 that varies at least one of the coverage and the capacity so as to decrease the difference between the coverage 110 and the first target value 112. The example in FIG. 1A illustrates a state in which the current value 111 of the coverage 110 is lower than the first target value 112 (short coverage).

In this case, the controller 152 controls the radio base station 101 so as to improve the coverage 110 to decrease the difference between the coverage 110 and the first target value 112. It is possible to decrease the difference between the first index value 113 and the second index value 123 in the above manner to balance the degree of achievement of the coverage with the degree of achievement of the capacity.

FIG. 1B illustrates a second example of control of the radio base station by the control apparatus according to the first embodiment. The same reference numerals are used in FIG. 1B to identify the same components illustrated in FIG. 1A. A description of such components is omitted herein. Also in the example in FIG. 1B, the magnitude of the difference between the first index value 113 and the second index value 123 exceeds the allowable value and the magnitude of the difference indicated by the first index value 113 is greater than the magnitude of the difference indicated by the second index value 123. The example in FIG. 1B illustrates a state in which the current value 111 of the coverage 110 is higher than the first target value 112 (over coverage).

In this case, the controller 152 controls the radio base station 101 so as to degrade the coverage 110 to decrease the difference between the coverage 110 and the first target value 112. It is possible to decrease the difference between the first index value 113 and the second index value 123 in the above manner to balance the degree of achievement of the coverage with the degree of achievement of the capacity.

FIG. 1C illustrates a third example of control of the radio base station by the control apparatus according to the first embodiment. The same reference numerals are used in FIG. 1C to identify the same components illustrated in FIG. 1A. A description of such components is omitted herein. Also in the example in FIG. 1C, the magnitude of the difference between the first index value 113 and the second index value 123 exceeds the allowable value. In the example in FIG. 1C, the magnitude of the difference indicated by the second index value 123 is greater than the magnitude of the difference indicated by the first index value 113. The example in FIG. 1C illustrates a state in which the current value 121 of the capacity 120 is lower than the second target value 122 (short capacity).

In this case, the controller 152 controls the radio base station 101 so as to improve the capacity 120 to decrease the difference between the capacity 120 and the second target value 122. It is possible to decrease the difference between the first index value 113 and the second index value 123 in the above manner to balance the degree of achievement of the coverage with the degree of achievement of the capacity.

FIG. 1D illustrates a fourth example of control of the radio base station by the control apparatus according to the first embodiment. The same reference numerals are used in FIG. 1D to identify the same components illustrated in FIG. 1A. A description of such components is omitted herein. Also in the example in FIG. 1D, the magnitude of the difference between the first index value 113 and the second index value 123 exceeds the allowable value. In the example in FIG. 1D, the magnitude of the difference indicated by the second index value 123 is greater than the magnitude of the difference indicated by the first index value 113. The example in FIG. 1D illustrates a state in which the current value 121 of the capacity 120 is higher than the second target value 122 (over capacity).

In this case, the controller 152 controls the operation state of the radio base station 101 so as to degrade the capacity 120 to decrease the difference between the capacity 120 and the second target value 122. It is possible to decrease the difference between the first index value 113 and the second index value 123 in the above manner to balance the degree of achievement of the coverage with the degree of achievement of the capacity.

As illustrated in FIG. 1A to FIG. 1D, the control apparatus 100 controls the radio base station 101 so as to decrease the difference in the coverage or the capacity having the greater difference from the target value to decrease the difference between the first index value 113 and the second index value 123. As a result, it is possible to balance the degree of achievement of the coverage with the degree of achievement of the capacity.

FIG. 1E illustrates a fifth example of control of the radio base station by the control apparatus according to the first embodiment. The same reference numerals are used in FIG. 1E to identify the same components illustrated in FIG. 1A. A description of such components is omitted herein. In the example in FIG. 1E, the coverage 110 and the capacity 120 before the control by the control apparatus 100 are the same as those in the example in FIG. 1A.

In this case, the controller 152 may control the operation state of the radio base station 101 so as to degrade the capacity 120 to decrease the difference between the capacity 120 and the second target value 122. It is possible to decrease the difference between the first index value 113 and the second index value 123 in the above manner to balance the degree of achievement of the coverage with the degree of achievement of the capacity.

FIG. 1F illustrates a sixth example of control of the radio base station by the control apparatus according to the first embodiment. The same reference numerals are used in FIG. 1F to identify the same components illustrated in FIG. 1C. A description of such components is omitted herein. In the example in FIG. 1F, the coverage 110 and the capacity 120 before the control by the control apparatus 100 are the same as those in the example in FIG. 1C.

In this case, the controller 152 may control the operation state of the radio base station 101 so as to degrade the coverage 110 to decrease the difference between the coverage 110 and the first target value 112. It is possible to decrease the difference between the first index value 113 and the second index value 123 in the above manner to balance the degree of achievement of the coverage with the degree of achievement of the capacity.

As illustrated in FIG. 1E and FIG. 1F, the control apparatus 100 may control the radio base station 101 so as to increase the difference in the coverage or the capacity having the smaller difference from the target value to decrease the difference between the first index value 113 and the second index value 123. As a result, it is possible to balance the degree of achievement of the coverage with the degree of achievement of the capacity.

As illustrated in FIG. 1A to FIG. 1F, with the control apparatus 100 according to the first embodiment, decreasing the difference between the first index value 113 and the second index value 123 allows the degree of achievement of the coverage to be balanced with the degree of achievement of the capacity. As a result, it is possible to suppress the over quality and the over processing to improve the operation efficiency.

### Examples of Communication System

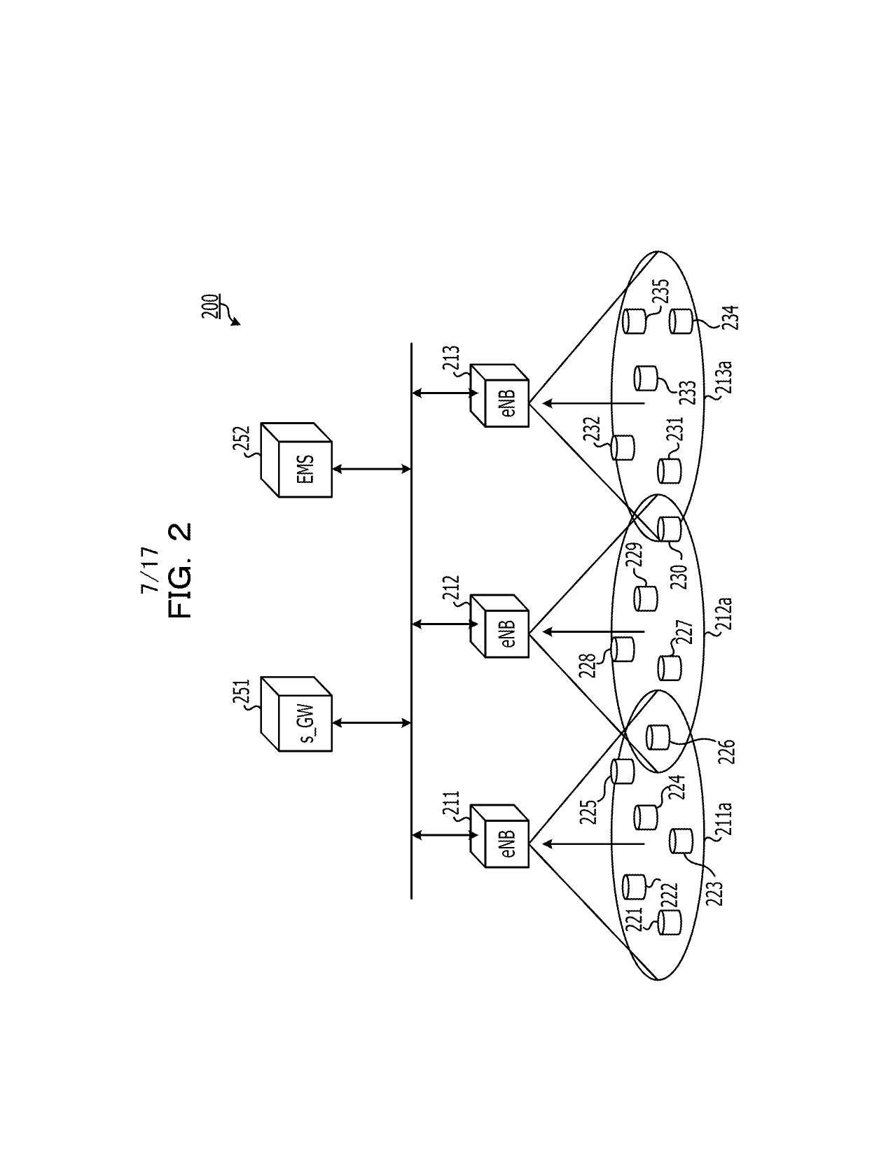

FIG. 2 illustrates a first exemplary communication system. A communication system 200 illustrated in FIG. 2 is an example of the communication system to which the control apparatus 100 is applied. The communication system 200 is, for example, a long term evolution (LTE) communication system or an LTE-Advanced communication system, such as an outdoor radio network. Specifically, the communication system 200 includes evolutional Nodes B (eNBs) 211 to 213, user equipment 221 to 235, a serving gateway (s-GW) 251, and an element management system (EMS) 252.

The eNBs 211 to 213 are radio base stations to be controlled by the control apparatus 100. Cells 211a, 212a, and 213a correspond to the eNBs 211 to 213, respectively. The eNBs 211 to 213 are connected to the s-GW 251 and the EMS 252.

The s-GW 251 is a gateway for radio access services, which performs switching between an Internet protocol (IP) network and radio access. The EMS 252 is a monitoring control station that monitors, controls, and manages the state of, for example, a network device.

The user equipment (UE) 221 to 235 are mobile terminals that are positioned in areas to which communication services are provided by the eNBs 211 to 213 and that establish the radio communication with the eNBs 211 to 213. The user equipment 221 to 226 are positioned in the cell 211a. The user equipment 226 to 230 are positioned in the cell 212a. The user equipment 230 to 235 are positioned in the cell 213a. In other words, the user equipment 226 is positioned in a portion where the cell 211a is overlapped with the cell 212a. The user equipment 230 is positioned in a portion where the cell 212a is overlapped with the cell 213a.

The control apparatus 100 is applicable to, for example, the EMS 252. This allows the degree of achievement of the coverage to be balanced with the degree of achievement of the capacity in an area including the cells 211a, 212a, and 213a. As a result, it is possible to suppress the over quality and the over processing in the communication system 200 to improve the operation efficiency.

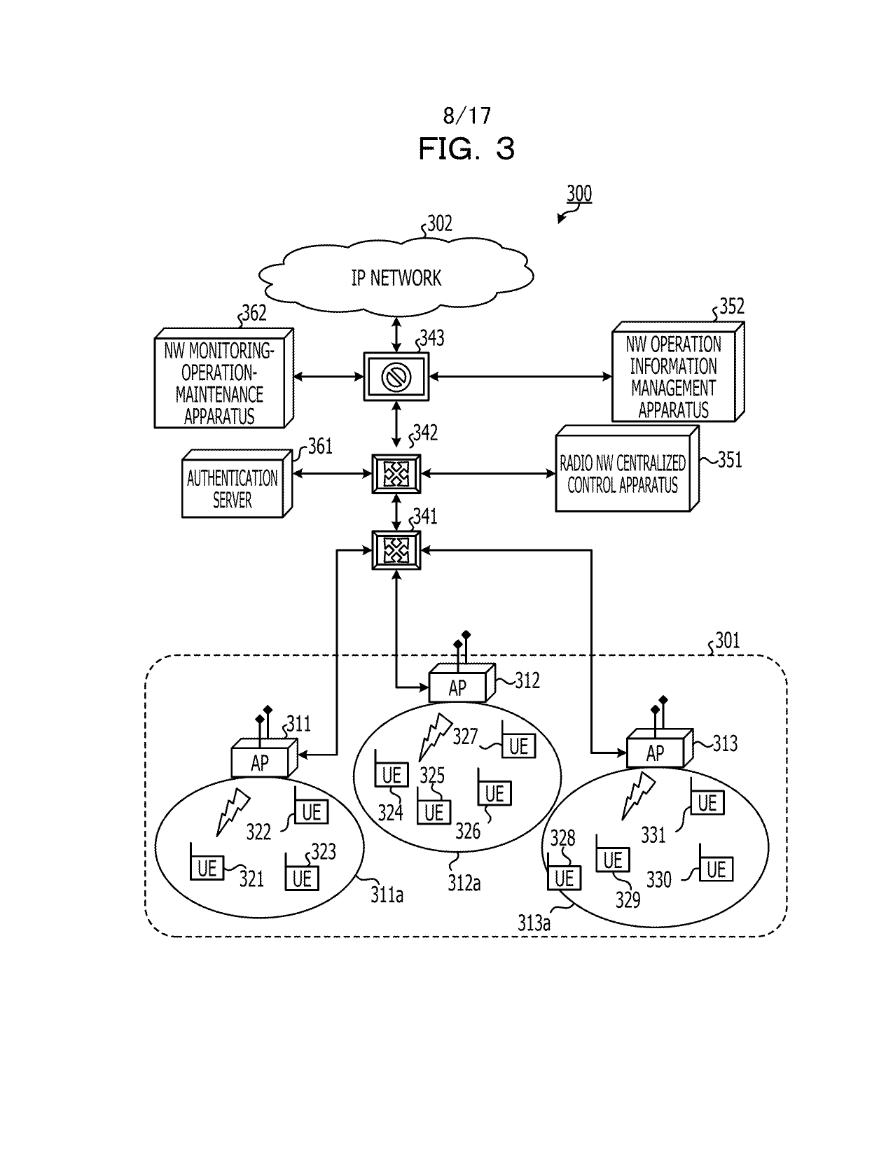

FIG. 3 illustrates a second exemplary communication system. A communication system 300 illustrated in FIG. 3 is an example of the communication system to which the control apparatus 100 is applied. The communication system 300 is an indoor femto cell network, such as an indoor radio network.

Specifically, the communication system 300 includes an area 301, an IP network 302, access points 311 to 313, user equipment 321 to 331, router switches 341 and 342, a gateway 343, a radio network centralized control apparatus 351, a network operation information management apparatus 352, an authentication server 361, and a network monitoring-operation-maintenance apparatus 362.

The access points 311 to 313 (APs) are radio base stations to be controlled by the control apparatus 100. Each of the access points 311 to 313 is, for example, a femto base station. The area 301 indicates a range to which communication services are provided by the access points 311 to 313.

Cells 311a, 312a, and 313a correspond to the access points 311 to 313, respectively. The access points 311 to 313 are connected to the IP network 302 via the router switches 341 and 342 and the gateway 343.

The user equipment 321 to 331 are mobile terminals that are positioned in the area 301 to which the communication services are provided by the access points 311 to 313 and that establish the radio communication with the access points 311 to 313. The user equipment 321 to 323 are positioned in the cell 311a and establishes the radio communication with the access point 311 to access, for example, the IP network 302. The user equipment 324 to 327 are positioned in the cell 312a and establishes the radio communication with the access point 312 to access, for example, the IP network 302. The user equipment 328 to 331 are positioned in the cell 313a and establishes the radio communication with the access point 313 to access, for example, the IP network 302.

The radio network centralized control apparatus 351 (radio NW centralized control apparatus) is connected to the router switch 342. The network operation information management apparatus 352 (NW operation information management apparatus) is connected to the gateway 343. The network monitoring-operation-maintenance apparatus 362 (NW monitoring-operation-maintenance apparatus) is connected to the gateway 343. The authentication server 361 is connected to the router switch 342.

The control apparatus 100 is applicable to, for example, the radio network centralized control apparatus 351. This allows the degree of achievement of the coverage to be balanced with the degree of achievement of the capacity in the area 301. As a result, it is possible to suppress the over quality and the over processing in the communication system 300 to improve the operation efficiency.

The communication system 300 is applicable to, for example, a corporate office, a shop building, and a large shopping mall. With the control apparatus 100, prioritization for every area (or spot) or prioritization for every user can be set to control the coverage and the capacity (described below). Accordingly, the application of the control apparatus 100 to the indoor femto cell network, such as the communication system 300, allows the coverage and the capacity of a target area to be flexibly controlled.

### Control by Control Apparatus

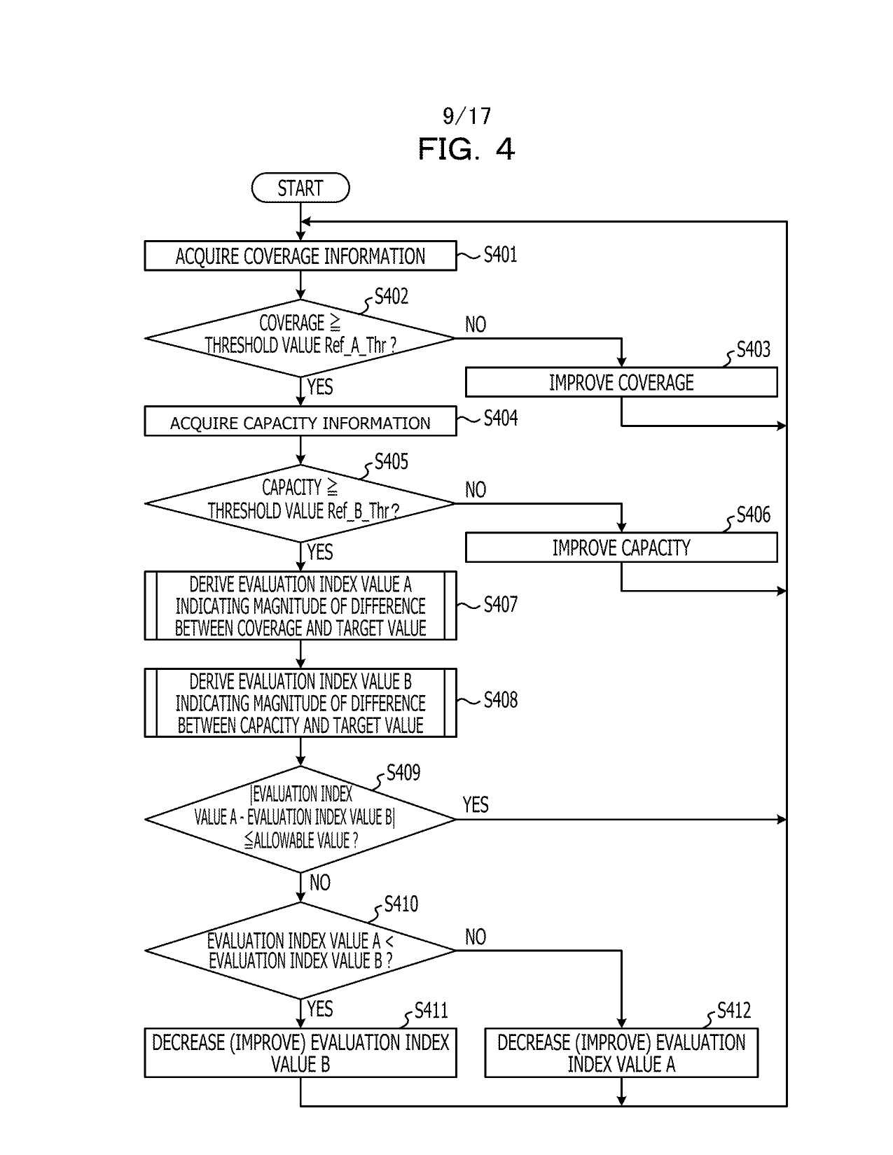

FIG. 4 is a flow chart illustrating an example of a control process by the control apparatus. The control apparatus 100 executes, for example, the following steps illustrated in FIG. 4. Referring to FIG. 4, in Step S401, the control apparatus 100 acquires coverage information. The coverage information indicates, for example, the coverage (for example, RSRP or SINR) of each spot in the target area.

In Step S402, the control apparatus 100 determines whether the coverage indicated by the coverage information acquired in Step S401 is higher than or equal to a given threshold value Ref_A_Thr. When the coverage information indicates the coverage of each spot in Step S402, the control apparatus 100 determines whether, for example, all the coverages of the respective spots are higher than or equal to the threshold value Ref_A_Thr. Alternatively, the control apparatus 100 may determine whether the average or the like of the coverages of the respective spots is higher than or equal to the threshold value Ref_A_Thr.

If the coverage is lower than the threshold value Ref_A_Thr (No in Step S402), in Step S403, the control apparatus 100 performs a process of improving the coverage. Then, the process goes back to Step S401. The control apparatus 100, for example, increases the transmission power of the radio base station to be controlled, adjusts the orientation of an antenna, or increases the number of the working radio base stations to improve the coverage in Step S403.

Alternatively, the control apparatus 100 may make a determination to increase the transmission power of the radio base station to be controlled, adjust the orientation of an antenna, or increase the number of the working radio base stations in Step S403. Then, the control apparatus 100 performs preliminary verification and simulation to the result of control based on the determination result. In this case, the control apparatus 100 acquires the coverage information based on the result of the preliminary verification and simulation in Step S401 subsequently performed. In addition, in this case, the control apparatus 100 reflects the determination result in the control of the radio base station in, for example, Step S411 or Step S412.

If the coverage is higher than or equal to the threshold value Ref_A_Thr (Yes in Step S402), in Step S404, the control apparatus 100 acquires capacity information. The capacity information indicates, for example, the capacity (the amount of traffic, etc.) of each user (mobile terminal) in the target area of the control apparatus 100.

In Step S405, the control apparatus 100 determines whether the capacity indicated by the capacity information acquired in Step S404 is higher than or equal to a given threshold value Ref_B_Thr. When the capacity information indicates the capacity of each user in Step S405, the control apparatus 100 determines whether, for example, all the capacities of the respective users are higher than or equal to the threshold value Ref_B_Thr. Alternatively, the control apparatus 100 may determine whether the average or the like of the capacities of the respective users is higher than or equal to the threshold value Ref_B_Thr.

If the capacity is lower than the threshold value Ref_B_Thr (No in Step S405), in Step S406, the control apparatus 100 performs a process of improving the capacity. Then, the process goes back to Step S401. The control apparatus 100, for example, increases the number of the working radio base stations to be controlled or increases the processing capacity (resource) of the radio base station to improve the capacity in Step S406.

Alternatively, the control apparatus 100 may make a determination to increase the number of the working radio base stations to be controlled or increase the processing capacity (resource) of the radio base station in Step S406. Then, the control apparatus 100 performs the preliminary verification and simulation to the result of control based on the determination result. In this case, the control apparatus 100 acquires the capacity information based on the result of the preliminary verification and simulation in Step S404 subsequently performed. In addition, in this case, the control apparatus 100 reflects the determination result in the control of the radio base station in, for example, Step S411 or Step S412.

If the capacity is higher than or equal to the threshold value Ref_B_Thr (Yes in Step S405), the process goes to Step S407. Steps S401 to S406 allow the minimum coverage (the threshold value Ref_A_Thr) and the minimum capacity (the threshold value Ref_B_Thr) to be ensured before the coverage is balanced with the capacity.

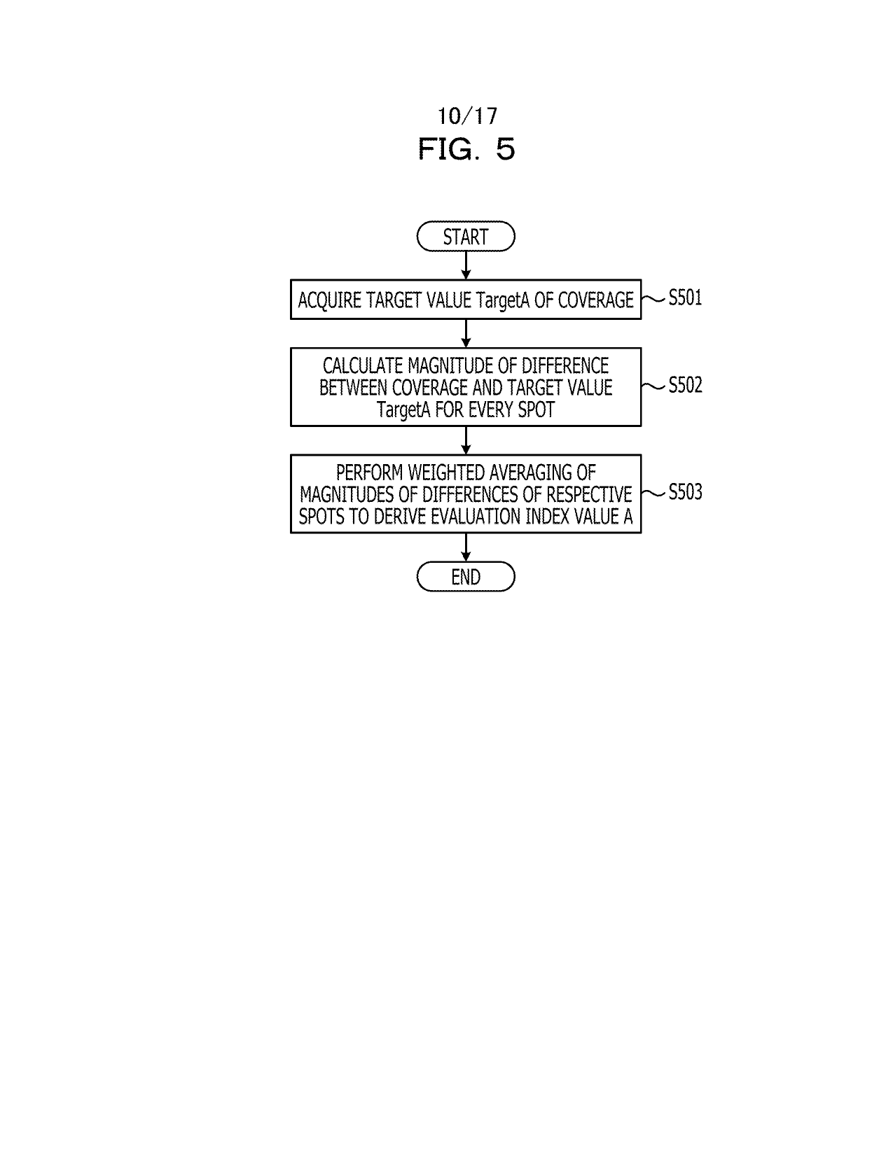

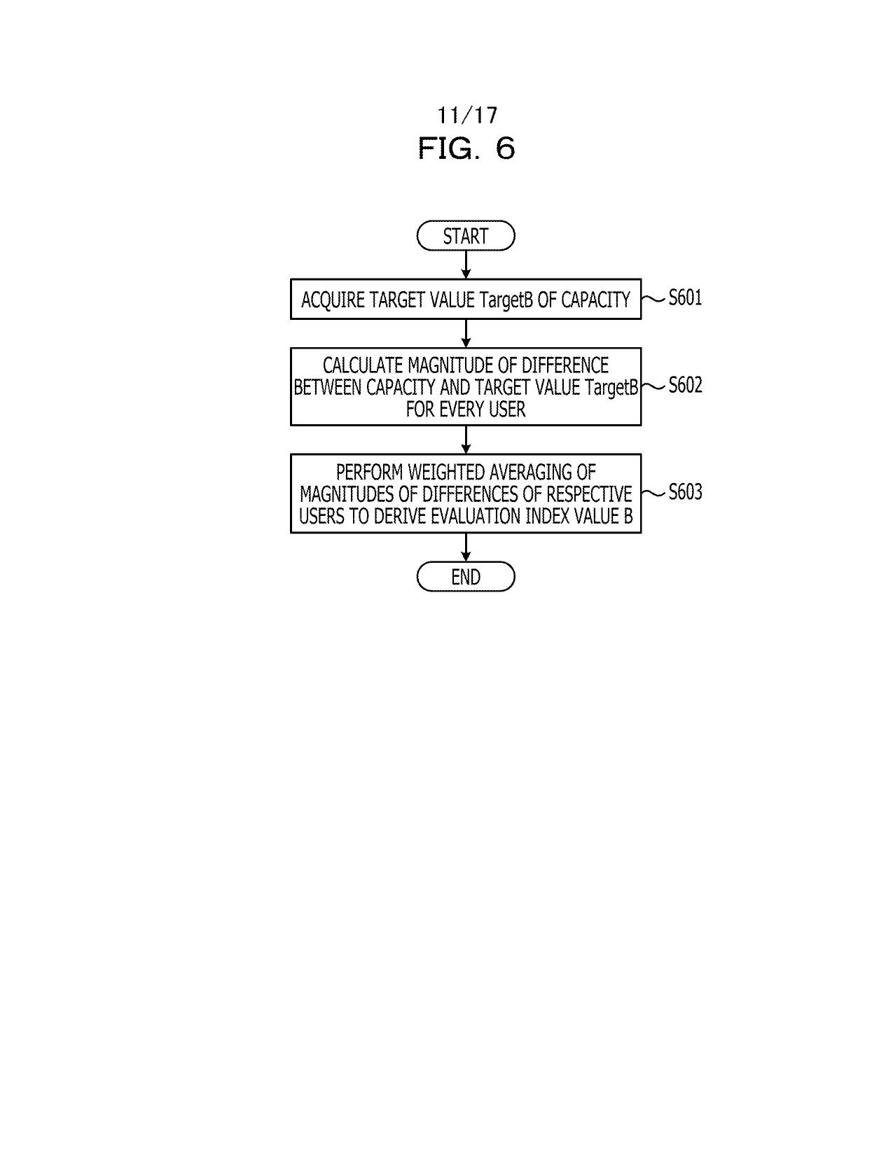

In Step S407, the control apparatus 100 derives an evaluation index value A (the first index value) indicating the magnitude of the difference between the coverage and a given target value. The derivation of the evaluation index value A will be described below (for example, refer to FIG. 5). In Step S408, the control apparatus 100 derives an evaluation index value B (the second index value) indicating the magnitude of the difference between the capacity and a given target value. The derivation of the evaluation index value B will be described below (for example, refer to FIG. 6). The order of Steps S407 and S408 may be reversed.

In Step S409, the control apparatus 100 determines whether the magnitude of the difference between the evaluation index value A and the evaluation index value B (|the evaluation index value A−the evaluation index value B|) derived in Steps S407 and S408, respectively, is smaller than or equal to a given allowable value. If the magnitude of the difference between the evaluation index value A and the evaluation index value B is smaller than or equal to the allowable value (Yes in Step S409), it is determined that the degree of achievement of the coverage is balanced with the degree of achievement of the capacity. In this case, the process goes back to Step S401.

If the magnitude of the difference between the evaluation index value A and the evaluation index value B exceeds the allowable value (No in Step S409), it is determined that the degree of achievement of the coverage is not balanced with the degree of achievement of the capacity. In this case, in Step S410, the control apparatus 100 determines whether the evaluation index value A is smaller (better) than the evaluation index value B.

If the evaluation index value A is smaller than the evaluation index value B (Yes in Step S410), in Step S411, the control apparatus 100 performs a process of decreasing (improving) the evaluation index value B. Then, the process goes back to Step S401. The process of decreasing (improving) the evaluation index value B is, for example, illustrated in FIG. 1C and FIG. 1D.

If the evaluation index value A is higher than or equal to the evaluation index value B (No in Step S410), in Step S412, the control apparatus 100 performs a process of decreasing (improving) the evaluation index value A. Then, the process goes back to Step S401. The process of decreasing (improving) the evaluation index value A is, for example, illustrated in FIG. 1A and FIG. 1B.

Through the above steps, it is possible to balance the degree of achievement of the coverage with the degree of achievement of the capacity while ensuring the minimum coverage and capacity. In addition, through Steps S401 to S406, it is possible to ensure the minimum coverage and capacity. For example, the coverage and/or the capacity can be low at the beginning of the operation of the control apparatus 100 or due to a large variation in environment of the radio service area. Against this, performing Step S401 to S406 before the coverage is balanced with the capacity in Steps S407 to S412 allows the minimum coverage and capacity to be ensured.

Although the control in which, after the coverage is made higher than or equal to the threshold value Ref_A_Thr, the capacity is made higher than or equal to the threshold value Ref_B_Thr is described in Steps S401 to S406, the capacity may be controlled prior to the coverage. Alternatively, the coverage and the capacity may be controlled concurrently (in parallel).

Each of the coverage and the capacity can be represented by, for example, a value within a numerical range [0 to 100]. In this case, each of the threshold values Ref_A_Thr and Ref_B_Thr can also be represented by, for example, a value (for example, 50) within the numerical range [0 to 100]. Each of the evaluation index values A and B can also be represented by, for example, a value within the numerical range [0 to 100].

However, the above numerical range and the setting values are only examples. For example, a reference degree of achievement may be represented by [±0], the direction of non-achievement may be represented by [minus: negative numerical values], and the direction of over-achievement may be represented by [plus: positive numerical values].

The threshold values Ref_A_Thr and Ref_B_Thr and the allowable value may be arbitrarily set in advance by a user (network administrator) of the control apparatus 100 in accordance with the policies of design of a radio area and/or provision of a service. This allows various area design conditions of the radio network and various service requests from the user to be flexibly supported.

For example, the threshold value Ref_A_Thr and the threshold value Ref_B_Thr can be varied to arbitrarily adjust the goals of the coverage and the capacity and the balance between the coverage and the capacity (the priority and weighting of the coverage and the capacity). As a result, it is possible to flexibly support the diversification of the operation policy.

When the threshold value Ref_A_Thr and the threshold value Ref_B_Thr are set to different values, the control apparatus 100, for example, may correct the result of comparison between the evaluation index value A and the evaluation index value B based on the difference between the threshold value Ref_A_Thr and the threshold value Ref_B_Thr. For example, in Step S409, |(the evaluation index value A−the evaluation index value B)−(Ref_B_Thr-Ref_A_Thr)| is calculated and the result of the calculation is compared with the allowable value. This allows the degree of achievement of the coverage to be compared with the degree of achievement of the capacity in a non-biased manner to balance the degree of achievement of the coverage with the degree of achievement of the capacity.

When the process goes back to Step S401, Step S401 may be performed after the control apparatus 100 waits for detection of a change in the area conditions or a variation in the user conditions by the network administrator. In this case, when any change in the area conditions and any variation in the user conditions do not occur, it is possible to keep the operation state of the radio base station to reduce the amount of processing involved in the control of the radio base station.

### Derivation of Evaluation Index Value A by Control Apparatus

FIG. 5 is a flow chart illustrating an example of the process of deriving the evaluation index value A by the control apparatus. The control apparatus 100 performs, for example, the following steps in Step S407 in FIG. 4. Referring to FIG. 5, in Step S501, the control apparatus 100 acquires a target value TargetA of the coverage. The target value TargetA is, for example, input by the user (the network administrator) of the control apparatus 100 via a user interface. The target value TargetA is set, for example, for every area.

In Step S502, the control apparatus 100 calculates the magnitude of the difference between the coverage indicated by the coverage information acquired in Step S401 in FIG. 4 and the target value TargetA acquired in Step S501 for every spot. In Step S503, the control apparatus 100 performs weighted averaging of the magnitudes of the differences of the respective spots calculated in Step S502 to derive the evaluation index value A. Then, the process of deriving the evaluation index value A is terminated.

The evaluation index value A indicating the magnitude of the difference between the coverage and the target value TargetA can be derived in the above manner. In addition, the weighting in Step S503 can be adjusted to derive the evaluation index value A in which the priority or the like for every spot is reflected. Factor information indicating the weighting factor of each spot in Step S503 is, for example, input by the user (the network administrator) of the control apparatus 100 via a user interface.

As described above, the derivation of the evaluation index value A by the weighted averaging of the magnitudes of the differences between the coverages and the target values TargetA of the respective points (spots) included in the target area allows the degree of achievement of the coverage to be evaluated with the priority or the like of each spot being reflected.

### Derivation of Evaluation Index Value B by Control Apparatus

FIG. 6 is a flow chart illustrating an example of the process of deriving the evaluation index value B by the control apparatus. The control apparatus 100 performs, for example, the following steps in Step S408 in FIG. 4. Referring to FIG. 6, in Step S601, the control apparatus 100 acquires a target value TargetB of the capacity. The target value TargetB is, for example, input by the user (the network administrator) of the control apparatus 100 via a user interface. The target value TargetB is set, for example, for every area.

In Step S602, the control apparatus 100 calculates the magnitude of the difference between the capacity indicated by the capacity information acquired in Step S404 in FIG. 4 and the target value TargetB acquired in Step S601 for every user. In Step S603, the control apparatus 100 performs the weighted averaging of the magnitudes of the differences of the respective users calculated in Step S602 to derive the evaluation index value B. Then, the process of deriving the evaluation index value B is terminated.

The evaluation index value B indicating the magnitude of the difference between the capacity and the target value TargetB can be derived in the above manner. In addition, the weighting in Step S603 can be adjusted to derive the evaluation index value B in which the priority or the like for every user is reflected. Factor information indicating the weighting factor of each user in Step S603 is, for example, input by the user (the network administrator) of the control apparatus 100 via a user interface.

As described above, the derivation of the evaluation index value B by the weighted averaging of the magnitudes of the differences between the capacities and the target values TargetB of the respective users using the communication service allows the degree of achievement of the capacity to be evaluated with the priority or the like of each user being reflected.

### Hardware Configuration of Radio Network Monitoring Control Apparatus

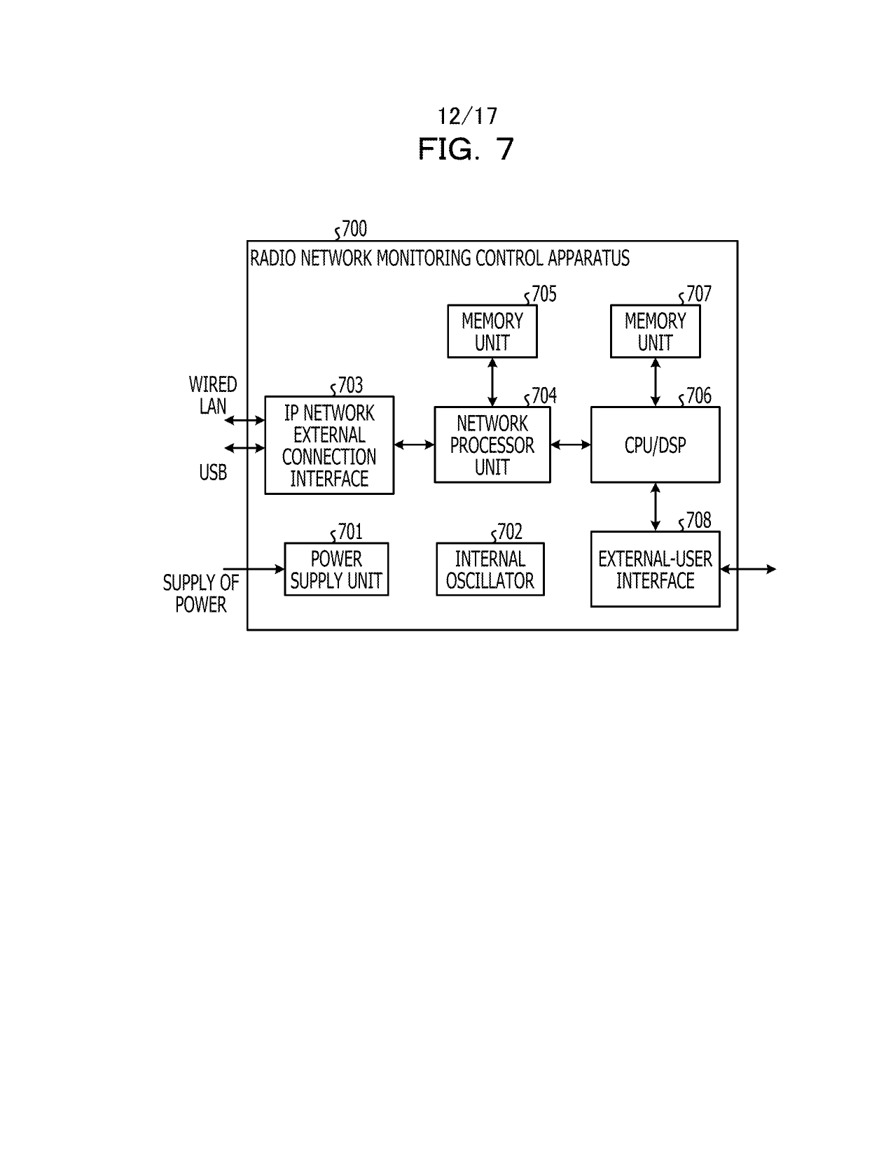

FIG. 7 illustrates an example of the hardware configuration of a radio network monitoring control apparatus. A radio network monitoring control apparatus 700 illustrated in FIG. 7 is an exemplary apparatus to which the control apparatus 100 is applied. The radio network monitoring control apparatus 700 is applicable to, for example, the EMS 252 (FIG. 2) or the network operation information management apparatus 352 (FIG. 3).

The radio network monitoring control apparatus 700 includes a power supply unit 701, an internal oscillator 702, an IP network external connection interface 703, a network processor unit 704, a memory unit 705, a main processor unit 706, a memory unit 707, and an external-user interface 708.

The power supply unit 701 supplies power that is externally supplied to each component in the radio network monitoring control apparatus 700. The internal oscillator 702 generates a clock signal determining an operation clock of each component in the radio network monitoring control apparatus 700 and supplies the generated clock signal to each component in the radio network monitoring control apparatus 700.

The IP network external connection interface 703 is, for example, connected to an IP network (for example, the IP network 302 in FIG. 3) via a wired local area network (LAN) or connected to an external device via a universal serial bus (USB). The IP network external connection interface 703 is, for example, connected to a radio base station to be controlled (for example, the eNBs 211 to 213 in FIG. 2 or the access points 311 to 313 in FIG. 3) via a wired LAN.

The network processor unit 704 is a circuit that establishes communication via the IP network external connection interface 703. The memory unit 705 is used as, for example, a working space of the network processor unit 704.

The main processor unit 706 (CPU/DSP) controls the entire radio network monitoring control apparatus 700. The main processor unit 706 is, for example, a central processing unit (CPU) or a digital signal processor (DSP). A multi-core processor may be used as the main processor unit 706. The memory unit 707 is used as, for example, a working space of the main processor unit 706.

The external-user interface 708 is an interface with an external peripheral device and/or the user. For example, the external-user interface 708 includes user interfaces including a display, a keyboard, and a mouse.

The control apparatus 100 is applicable to, for example, the radio network monitoring control apparatus 700. In this case, the control apparatus 100 is capable of acquiring the information on the coverage and the capacity via, for example, the IP network external connection interface 703 and the network processor unit 704. The control apparatus 100 is capable of calculating the first index value and the second index value with the main processor unit 706.

The comparator 151 is realized by, for example, the main processor unit 706. The controller 152 is realized by, for example, the main processor unit 706, the network processor unit 704, and the IP network external connection interface 703.

### Hardware Configuration of Radio Base Station

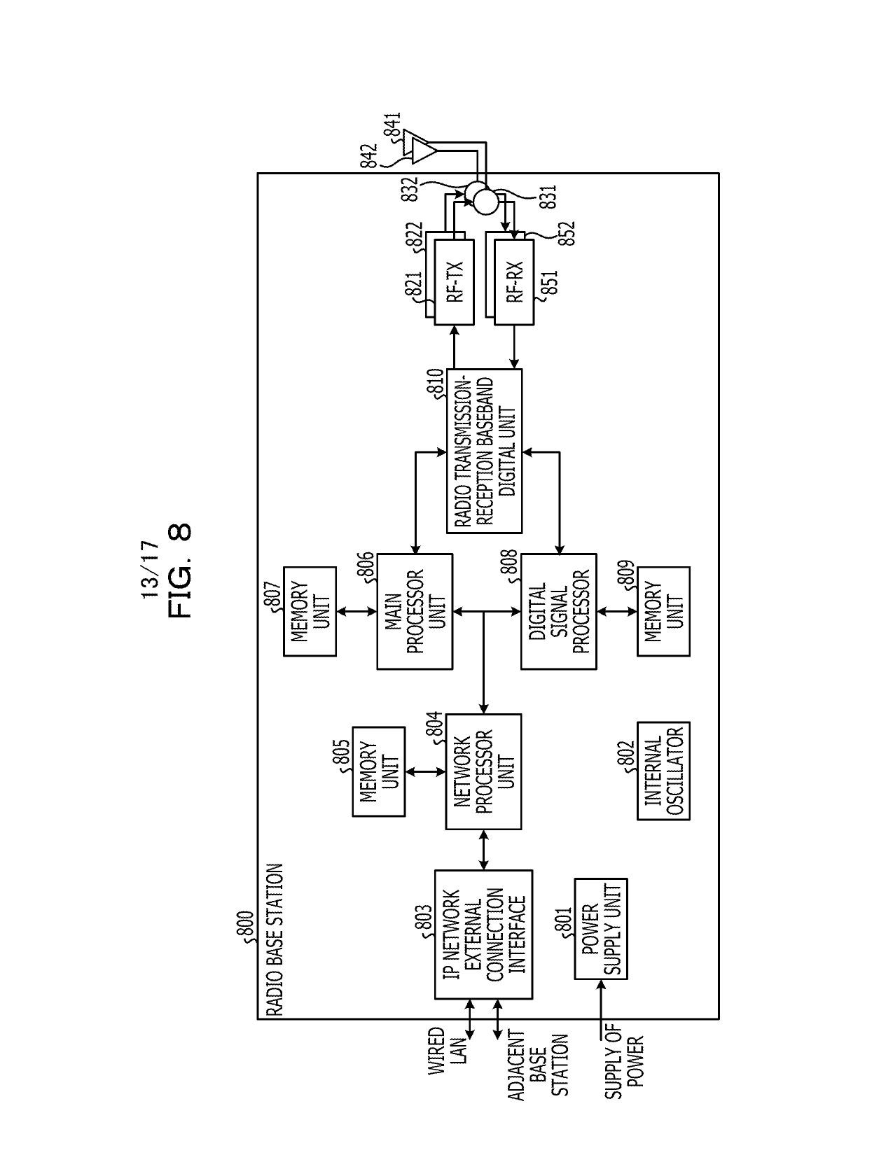

FIG. 8 illustrates an example of the hardware configuration of a radio base station. A radio base station 800 illustrated in FIG. 8 is an exemplary radio base station to be controlled by the control apparatus 100. The radio base station 800 is applicable to, for example, the eNBs 211 to 213 (FIG. 2) or the access points 311 to 313 (FIG. 3).

The radio base station 800 includes a power supply unit 801, an internal oscillator 802, an IP network external connection interface 803, a network processor unit 804, a memory unit 805, a main processor unit 806, a memory unit 807, a digital signal processor 808, a memory unit 809, a radio transmission-reception baseband digital unit 810, transmitters 821 and 822, splitters 831 and 832, antennas 841 and 842, and receivers 851 and 852.

The power supply unit 801 supplies power that is externally supplied to each component in the radio base station 800. The internal oscillator 802 generates a clock signal determining an operation clock of each component in the radio base station 800 and supplies the generated clock signal to each component in the radio base station 800.

The IP network external connection interface 803 is, for example, connected to an IP network (for example, the IP network 302 in FIG. 3) or an adjacent base station via a wired LAN. The IP network external connection interface 803 is, for example, connected to the radio network monitoring control apparatus 700 (for example, the eNBs 211 to 213 in FIG. 2 or the access points 311 to 313 in FIG. 3) controlling the radio base station 800 via a wired LAN.

The network processor unit 804 is a circuit that establishes communication via the IP network external connection interface 803. The memory unit 805 is used as, for example, a working space of the network processor unit 804.

The main processor unit 806 controls the entire radio base station 800. The memory unit 807 is used as, for example, a working space of the main processor unit 806. The digital signal processor 808 controls data processing in the radio communication by the radio transmission-reception baseband digital unit 810. The memory unit 809 is used as, for example, a working space of the digital signal processor 808.

The radio transmission-reception baseband digital unit 810 supplies a transmission signal in a baseband bandwidth to the transmitters 821 and 822. In addition, the radio transmission-reception baseband digital unit 810 performs baseband processing to reception signals supplied from the receivers 851 and 852. The transmitters 821 and 822 (RF-TXs) each convert the transmission signal supplied from the radio transmission-reception baseband digital unit 810 into a signal in a radio-frequency (RF) bandwidth. The transmitters 821 and 822 supply the converted signals to the splitters 831 and 832, respectively.

The splitters 831 and 832 supply the transmission signals supplied from the transmitters 821 and 822 to the antennas 841 and 842, respectively. In addition, the splitters 831 and 832 supply transmission signals supplied from the antennas 841 and 842 to the receivers 851 and 852, respectively. The antennas 841 and 842 wirelessly transmit the transmission signals supplied from the splitters 831 and 832, respectively.

In addition, the antennas 841 and 842 supply signals wirelessly received to the splitters 831 and 832, respectively. The receivers 851 and 852 (RF-RXs) convert the signals in the RF bandwidth supplied from the splitters 831 and 832, respectively, into signals in the baseband bandwidth and supply the converted signals to the radio transmission-reception baseband digital unit 810.

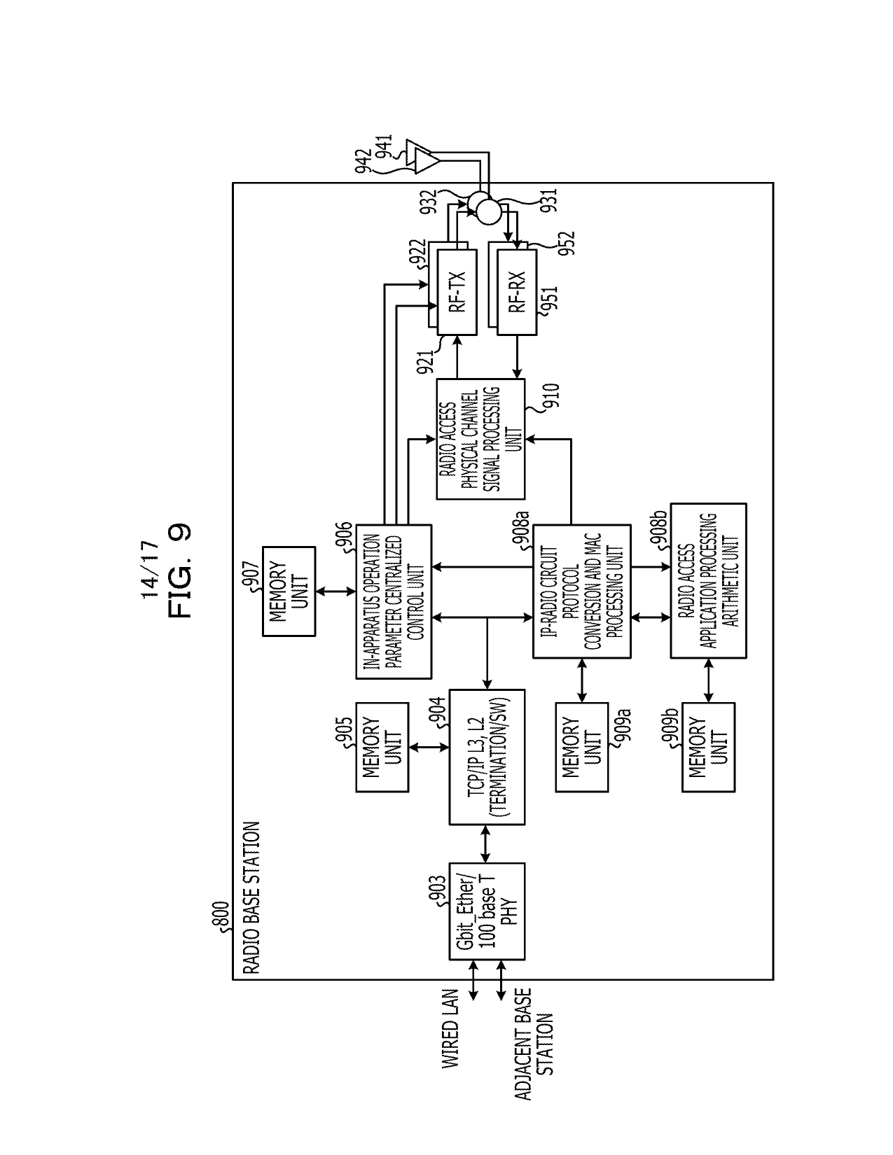

FIG. 9 illustrates exemplary functional blocks in the radio base station. As illustrated in FIG. 9, in the radio base station 800, a physical layer interface 903, a Transmission Control Protocol (TCP)/Internet Protocol (IP) terminal 904, a memory unit 905, an in-apparatus operation parameter centralized control unit 906, a memory unit 907, an IP-radio circuit protocol conversion and Media Access Control (MAC) processing unit 908a, a radio access application processing arithmetic unit 908b, a memory unit 909a, a memory unit 909b, a radio access physical channel signal processing unit 910, a transmitter 921, a transmitter 922, a splitter 931, a splitter 932, an antenna 941, an antenna 942, a receiver 951, and a receiver 952 are realized by the hardware configuration in FIG. 8.

The physical layer interface 903 (Gbit_Ether/100 base T PHY) is, for example, an Ethernet (registered trademark) interface of the order of several gigabits. The physical layer interface 903 is realized by, for example, the IP network external connection interface 803 illustrated in FIG. 8.

The TCP/IP terminal 904 (TCP/IP L3, L2 (termination/SW)) performs termination and switching of TCP/IP processing in the communication via the physical layer interface 903. The TCP/IP terminal 904 is realized by, for example, the network processor unit 804 illustrated in FIG. 9. The memory unit 905 is used as, for example, a working space of the TCP/IP terminal 904.

The in-apparatus operation parameter centralized control unit 906 controls the operation state (the operation parameters) of the radio base station 800. For example, the in-apparatus operation parameter centralized control unit 906 controls the operation state of the radio base station 800 based on a control instruction signal received from the radio network monitoring control apparatus 700 through the TCP/IP terminal 904 and the physical layer interface 903.

Specifically, the in-apparatus operation parameter centralized control unit 906 varies the processing capacity (resource) of the radio access physical channel signal processing unit 910 or controls the transmitters 921 and 922 to vary, for example, the transmission power and/or the orientation of the antennas. The in-apparatus operation parameter centralized control unit 906 is realized by, for example, the main processor unit 806 illustrated in FIG. 8. The memory unit 907 is used as, for example, a working space of the in-apparatus operation parameter centralized control unit 906.

The IP-radio circuit protocol conversion and MAC processing unit 908a performs protocol conversion between the IP communication with, for example, the physical layer interface 903 and the radio communication with, for example, the antennas 941 and 942 to provide a relay between the IP communication and the radio communication. In addition, the IP-radio circuit protocol conversion and MAC processing unit 908a processes a MAC layer. The IP-radio circuit protocol conversion and MAC processing unit 908a is realized by, for example, the digital signal processor 808 illustrated in FIG. 8. The memory unit 909a is used as, for example, a working space of the IP-radio circuit protocol conversion and MAC processing unit 908a.

The radio access application processing arithmetic unit 908b performs arithmetic processing of an application concerning the radio access of a mobile terminal establishing the radio communication with the radio base station 800. The radio access application processing arithmetic unit 908b is realized by, for example, the digital signal processor 808 illustrated in FIG. 8. The memory unit 909b is used as, for example, a working space of the radio access application processing arithmetic unit 908b.

The radio access physical channel signal processing unit 910 controls the radio access of a mobile terminal establishing the radio communication with the radio base station 800. In addition, the radio access physical channel signal processing unit 910 performs signal processing on a physical channel between the radio base station 800 and the mobile terminal. The radio access physical channel signal processing unit 910 is realized by, for example, the radio transmission-reception baseband digital unit 810 illustrated in FIG. 8.

The transmitters 921 and 922, the splitters 931 and 932, the antennas 941 and 942, and the receivers 951 and 952 have the same configurations as those of the transmitters 821 and 822, the splitters 831 and 832, the antennas 841 and 842, and the receivers 851 and 852, respectively.

As described above, with the control apparatus 100 according to the first embodiment, the operation state of the radio base station can be controlled so as not to increase the difference between the degree of achievement of the coverage and the degree of achievement of the capacity to balance the degree of achievement of the coverage with the degree of achievement of the capacity. As a result, it is possible to suppress the over quality and the over processing to improve the operation efficiency of working equipment, power, and so on.

### Second Embodiment

Points in a second embodiment different from the first embodiment will now be described. The control apparatus 100 according to the second embodiment derives the evaluation index value B (the second index value) based on quality of experience of a user using a communication service.

For example, the control apparatus 100 according to the second embodiment acquires device operation information from a mobile terminal. The device operation information indicates, for example, the time of an application operation (scrolling on a screen, enlargement, or selection click), the operation interval, or the intensity of a touch operation (finger pressure sensor). Then, the control apparatus 100 derives the quality of experience of the user based on the acquired device operation information to derive the evaluation index value B based on the derived quality of experience.

### Derivation of Evaluation Index value B by Control Apparatus

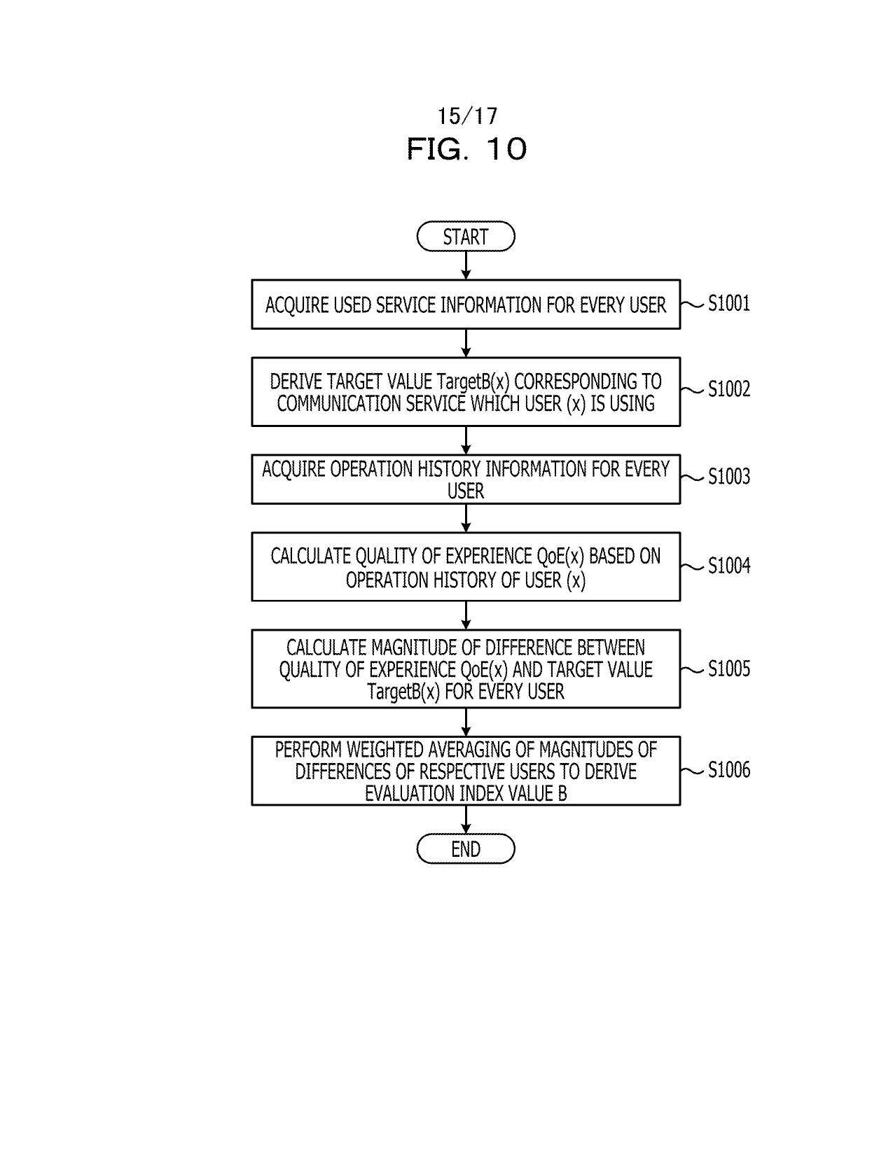

FIG. 10 is a flow chart illustrating an example of a process of deriving the evaluation index value B by the control apparatus according to the second embodiment. The control apparatus 100 according to the second embodiment executes, for example, the following steps in Step S408 illustrated in FIG. 4.

Referring to FIG. 10, in Step S1001, the control apparatus 100 acquires used service information for every user. The used service information indicates, for example, the kind of a communication service which the user is using with a mobile terminal establishing the radio communication with the radio base station to be controlled. For example, the control apparatus 100 is capable of acquiring the used service information from the mobile terminal via the radio base station to be controlled.

In Step S1002, the control apparatus 100 derives a target value TargetB(x) corresponding to the communication service which a user (x) is using based on the used service information acquired in Step S1001. For example, correspondence information in which the kind of each communication service is associated with the target value TargetB is stored in the memory of the control apparatus 100. The correspondence information is, for example, a correspondence table between the kind of the communication service and the target value TargetB or a function to calculate the target value TargetB based on the kind of the communication service.

The control apparatus 100 acquires the target value TargetB corresponding to the kind of the communication service indicated by the used service information acquired in Step S1001 from the correspondence information as the target value TargetB(x). The control apparatus 100 is capable of acquiring the target value TargetB(x) corresponding to the communication service which the user (x) is using in the above manner.

In Step S1003, the control apparatus 100 acquires operation history information for every user. The operation history information indicates, for example, the history of the operations of the mobile terminal by the user in the communication service which the user is using. The operation history information includes, for example, the kind of the operation of the mobile terminal by the user and the time interval between operations. For example, the control apparatus 100 is capable of acquiring the operation history information from the mobile terminal via the radio base station to be controlled.

In Step S1004, the control apparatus 100 calculates quality of experience QoE(x) based on the operation history of the user (x) based on the operation history information acquired in Step S1003. The quality of experience QoE(x) is an index value indicating the quality of experience when the user (x) is operating the mobile terminal. The calculation of the quality of experience QoE(x) will be described below.

In Step S1005, the control apparatus 100 calculates the magnitude of the difference between the quality of experience QoE(x) calculated in Step S1004 and the target value TargetB(x) derived in Step S1002 for every user. In Step S1006, the control apparatus 100 performs the weighted averaging of the magnitudes of the differences of the respective users calculated in Step S1005 to derive the evaluation index value B. Then, the process of deriving the evaluation index value B is terminated.

The evaluation index value B indicating the magnitude of the difference between the quality of experience of the user (x) and the target value TargetB(x) corresponding to the communication service which the user (x) is using can be derived in the above manner. In addition, the weighting in Step S1006 can be adjusted to derive the evaluation index value B in which the priority of each user, etc. is reflected.

Although the case in which the evaluation index value B is derived based on the quality of experience of the user (x) is described here, the evaluation index value B may be derived based on an index value, such as the throughput described in the first embodiment, and the quality of experience of the user (x).

### Specific Examples of Derivation of Each Evaluation Index Value

Specific examples of derivation of each evaluation index value by the control apparatus 100 will now be described. The control apparatus 100 evaluates sensible performance of the user based on information on, for example, operations of a terminal device or the history or the time interval of operations on an application screen which is being used, calculates the performance of the radio communication line based on the result of the evaluation, and derives the evaluation index value B based on the result of the calculation. The information on the time interval includes life log information on the user. Logs of times, locations, and operations may be stored in the background of the application.

The control apparatus 100, for example, sets the target values of the capacities (service conditions) and evaluates the actual usage status of a communication service to derive the magnitude of the difference between each target value and the current value. Six kinds of communication services: Internet Web (display, search, and link), thin client (remote connection and editing of data), movie and streaming (download and display), mail transmission and reception (text, illustration, and image), online game (network connection and match), and application and software update (download and installation) are assumed here as examples of the kinds of communication services used by the user. However, the kinds of communication services are diversified depending on the radio services and the applications thereof and are not limited to the above ones.

In the control apparatus 100, main service conditions (capacities) for which target performance qualities are assumed in provision of a radio communication service by using a radio access network are set as Key Performance Indicators (KPIs). Targets (target values) are set based on the operation policy or the application of the communication service.

The KPIs include, for example, service categories (uniquely determined in association with the kinds of service applications), the level of real time and the frequency of a request to update information (relative measure), and the arrival rate of packets (relative measure). The service categories are uniquely defined in association with the above six kinds. The service categories are defined as one KPI and also serve as tags in comparison with other KPIs. In other words, when classification into multiple services is performed, the services having the same targets for the other KPIs are classified into the same category.

In the setting of each target (target value), a relative difference is described in abstract representation. In detailed circuit implementation, the settings of, for example, “low-medium-high” and “small-medium-large” are digitized into “1-2-3.” Alternatively, the settings may be digitized into “1 to 5”, which correspond to the top level, the bottom level, and intermediate levels. Accordingly, the settings can be processed as numerical values to perform the arithmetic operation.

In the control apparatus 100, main KPIs are defined for determination of the evaluation result of the current radio access service that has been actually provided. The usage state of the KPI information for every terminal device (user) that is wirelessly connected is held and updated in time series in synchronization with the radio access time.

The main KPIs include, for example, received power (the reception intensity of a radio signal), the SINR, the frequency of occurrence of re-transmission (the incidence of re-transmission), the transfer rate of a radio packet, and the usage state of a radio resource (frequency band and transmission power). The frequency of occurrence of re-transmission indicates the incidence of a state in which the same information is re-transmitted upon occurrence of a packet error at the reception side.

### KPIs in Setting of Targets Concerning Service Conditions and Calculation of Current Values

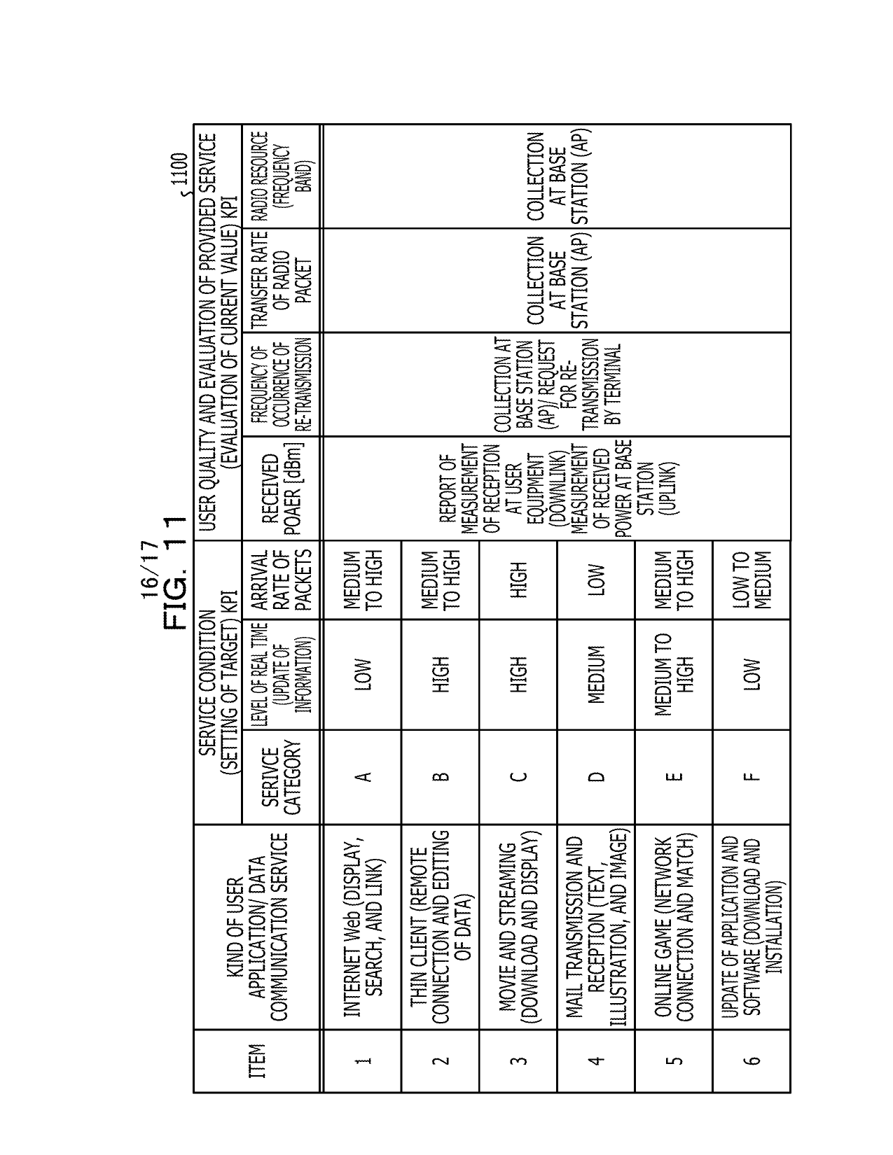

A table 1100 in FIG. 11 illustrates examples of the KPIs in setting of the targets concerning service conditions and calculation of the current values. The table 1100 in FIG. 11 is stored in, for example, the memory in the control apparatus 100. In the table 1100, the KPIs for setting the service conditions (target values) are associated with the KPIs for calculating user qualities and the evaluation values of a provided service for the respective kinds (six kinds) of communication services.

In the control apparatus 100, sensible performance conditions to accept a communication service are set for the user using the radio access service as the targets of the provision of the service. The sensible performance conditions include the size of packet data (the amount of information of request data that is assumed and update to new information), the operability (the user of the terminal device performs many operations), and the duration time of one access.

In the setting of each target (target value), a relative difference is described in abstract representation. In detailed circuit implementation, the settings of, for example, “low-medium-high” and “small-medium-large” are digitized into “1-2-3.” Alternatively, the settings may be digitized into “1 to 5”, which correspond to the top level, the bottom level, and intermediate levels. Accordingly, the settings can be processed as numerical values to perform the arithmetic operation.

Main KPIs used for evaluating the quality of experience of the user include, for example, the sizes of transmission packets (information on allocation of radio packets by the base station (AP) and terminal information), a terminal operation log (touch of the screen, key operations, and an application history), the connection time, and the processing load (processing of baseband radio signals at the base station (AP) side: the load on the CPU). In the control apparatus 100, the usage state of the KPI information for every terminal device (user) that is wirelessly connected is held and updated in time series in synchronization with the radio access time.

### KPIs in Setting of Targets Concerning Sensible Performance Conditions and Calculation of Current Values

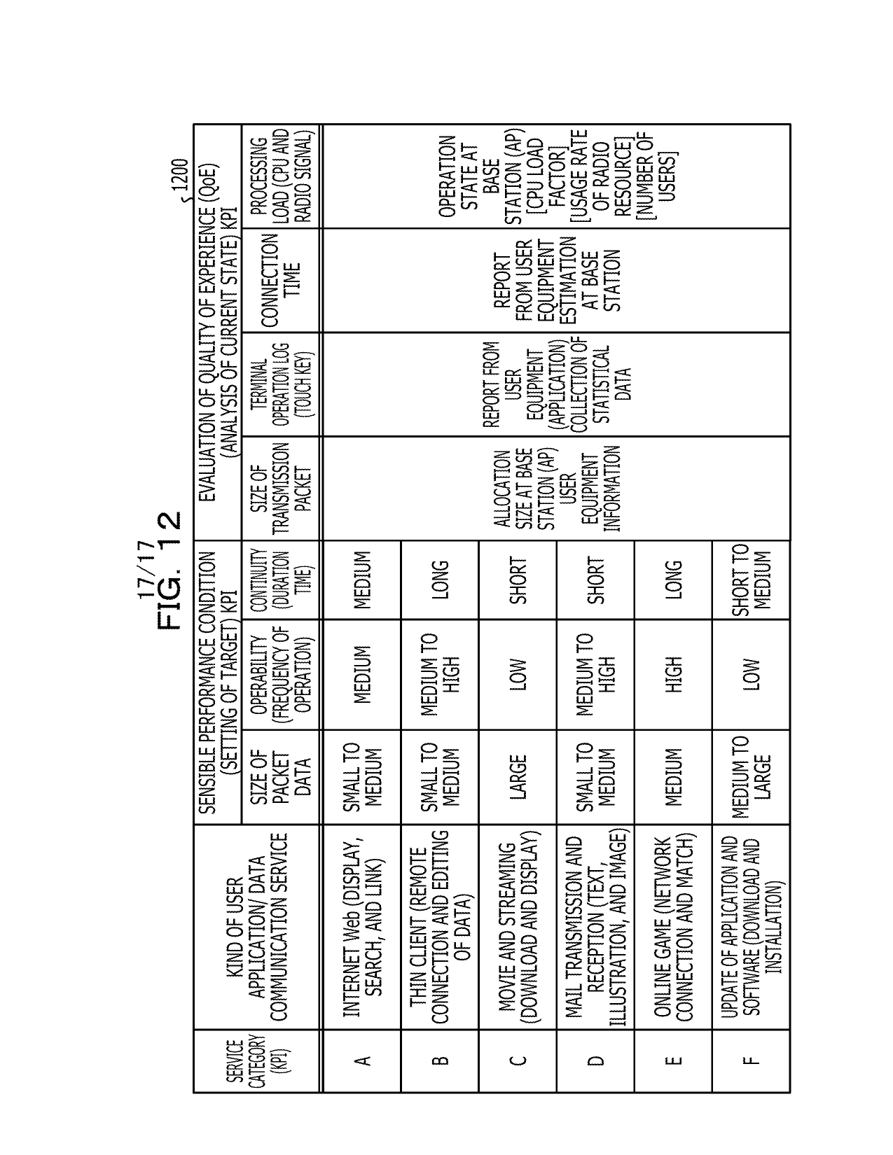

A table 1200 in FIG. 12 illustrates examples of the KPIs in setting of the targets concerning sensible performance conditions and calculation of the current values. The table 1200 in FIG. 12 is stored in, for example, the memory in the control apparatus 100. In the table 1200, the KPIs for setting the sensible performance conditions (target values) are associated with the KPIs for calculating the evaluation values of the quality of experience QoE for the respective kinds (six kinds) of communication services.

The evaluation index values in the control apparatus 100 are compared with each other for every area (or point) or for every user, the elements of the evaluation index values are collected, and the result of the collection is divided by the parameter of the collection, such as the number of users. In addition, the time average of the evaluation index values for every unit time (for example, 10 frames to 100 frames) in the time direction is acquired based on the radio access frame as the current performance evaluation value.

Specifically, an evaluation index value [x] in the control apparatus 100 is capable of being calculated by the following equation: the evaluation index value [x]=“the target setting value of a condition [x]”−[“the current performance evaluation value of the condition [x] that is provided”/{“(radio access) unit time and “the number of users” or “the number of points (the parameter)}].

As for design conditions of each area (for example, specification of an important point in the area) concerning the evaluation index value A, location information (layout information of an indoor floor) on the area or point is specified with the area and the request targets are set with the intensity of the received power or the SINR in the radio propagation.

As for the radio propagation state (the power or the SINR) of an area to which a communication service is actually provided, for example, the radio propagation state notified to the radio base station as the result of measurement of the reception at the user equipment is used. In addition, the number of users existing at a target point and the notification information on each user are acquired for every point, the acquired information is subjected to the time average, and the result of the time average is used as the performance evaluation value of the current area or point. The differences between the target setting values described above and the performance evaluation values are calculated and the results of the calculation are compared with each other to calculate the evaluation index value B.

The target setting value (the target value TargetA) for deriving the evaluation index value A is set as the design condition for the intensity of the received power or the SINR. The current value for deriving the evaluation index value A is calculated by the time average of the received powers or the SINRs of the respective users at a target point.

As for the evaluation index value B, the sensible performance conditions (target values) assumed by the corresponding communication service, among the service categories (A, B, . . . , and F) (refer to FIG. 11 and FIG. 12), are applied to the respective users based on the application or the radio access service which the user is using.

The target setting value (the evaluation index value B) for deriving the evaluation index value B results from comparison and collection of the individual KPIs specified in the service categories of each user. The current value for deriving the evaluation index value B results from comparison and collection of the individual KPIs specified in the service categories of each user.

At this time, the comparison of the evaluation index values is performed by using the relative numerical values (five-stage evaluation: 1 to 5) and the operation count, the packet size, and the duration time are replaced with relative numerical values in the five stages in consideration of the time when the operation count, the packet size, and the duration time are assumed. The relative numerical values in the five stages are generally increased with the increasing operation count, the increasing packet size, and the increasing duration time in the replacement.

The optimal settings and the result of the evaluation are varied depending on the individual environments and applications in the actual operation of the service. Accordingly, the numerical range that is set in each KPI and the relative levels (five stages) may be subjected, for example, fine tuning at an early stage of the operation in order to achieve the optimal resolution of the radio network configuration and the implementation of the apparatus during the operation.

As described above, the control apparatus 100 according to the second embodiment acquires the performance information indicating the sensible performance of the user in each communication service and the correspondence information in which the target values of the sensible performance are associated with the respective kinds of communication services. Then, the control apparatus 100 derives the target values corresponding to the kind of the communication service which the user is using based on the acquired correspondence information and calculates the second index value based on the magnitudes of the differences between the sensible performance values indicated by the performance information and the derived target values.

Accordingly, the degree of achievement of the capacity can be evaluated in accordance with the request for the radio performance that is varied depending on the content (for example, the movie and streaming, the game, or the Web) of the communication service. As a result, it is possible to flexibly control the radio base station depending on the content of the communication service which the user is using.

An acquiring unit that acquires the performance information indicating the sensible performance of the user is realized by, for example, the IP network external connection interface 703, the network processor unit 704, and the main processor unit 706 illustrated in FIG. 7. Specifically, the radio network monitoring control apparatus 700 to which the control apparatus 100 is applied is capable of acquiring the operation history information with the IP network external connection interface 703 and the network processor unit 704. The radio network monitoring control apparatus 700 is capable of acquiring the performance information by performing the arithmetic operation based on the acquired operation history information with the main processor unit 706.

An acquiring unit that acquires the correspondence information in which the target values of the sensible performance are associated with the respective kinds of communication services is realized by, for example, the main processor unit 706 and the memory unit 707 illustrated in FIG. 7. Specifically, storing the correspondence information in the memory unit 707 in advance and reading out the stored correspondence information with the main processor unit 706 allow the correspondence information to be acquired.

A deriving unit that derives the target values corresponding to the kind of communication service which the user is using based on the correspondence information is realized by, for example, the main processor unit 706 illustrated in FIG. 7. A calculating unit that calculates the second index value based on the magnitudes of the differences between the sensible performance values indicated by the performance information and the derived target values is realized by, for example, the main processor unit 706 and the memory unit 707 illustrated in FIG. 7.

For example, the control apparatus 100 uses information on the history and the time interval concerning operations of a terminal device and operations on the screen of an application to evaluate the sensible performance of the user using the radio communication service. Specifically, the control apparatus 100 collects information on operations on a touch panel, such as a smart phone or a tablet personal computer (PC), and information on the usage state of a user application (mail, movie and streaming, game, the Internet search, or network catalogue and purchase).

Accordingly, the control apparatus 100 is capable of acquiring the operation log and the operation count, the operation frequency, the time interval, etc. of operation buttons by the user for every kind of application. The control apparatus 100 evaluates the actual sensible performance of the user and derives the evaluation index value B based on the evaluated sensible performance. Accordingly, it is possible to evaluate the degree of achievement of the capacity based on the actual sensible performance of the user for each communication service which the user is using.

As described above, according to the control apparatus, the communication system, the control program, and the control method, it is possible to improve the operation efficiency. For example, it is possible to evaluate the provision of a radio area (radio quality) and the degree of achievement of realization of a service by the user using the service to control the operation parameters of the radio base station so as to balance the area design orientation with the user service orientation.

The control methods described in the above embodiments are realized by a computer, such as a personal computer or a workstation, which executes a program prepared in advance. The program is recorded on a computer-readable recording medium, such as a hard disk, a flexible disk, a compact disk-read only memory (CD-ROM), a magneto-optical disk (MO), or a digital versatile disk (DVD), and is read out from the recording medium by the computer to be executed. The program may be a transmission medium capable of being distributed over a network, such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control apparatus comprising:
a memory; and
a processor that executes a procedure stored in the memory, the procedure including,
comparing a first index value with a second index value, the first index value indicating a magnitude of a difference between a coverage in an area to which a communication service is provided by a radio base station to be controlled and a first target value, the second index value indicating a magnitude of a difference between a capacity of the communication service in the area and a second target value, and
controlling an operation state of the radio base station that varies at least one of the coverage and the capacity so as to decrease a difference between the first index value and the second index value when the result of the comparing indicates that the magnitude of the difference between the first index value and the second index value exceeds a given value.

2. The control apparatus according to claim 1, wherein the procedure includes,
acquiring performance information indicating sensible performance of a user in the communication service and correspondence information in which each target value of the sensible performance is associated with each kind of the communication service;
deriving a target value corresponding to the kind of the communication service which the user is using based on the correspondence information acquired by the acquiring; and
calculating the second index value based on a magnitude of a difference between the sensible performance indicated by the performance information and the target value,
wherein the comparing compares the first index value with the second index value calculated by the calculating.

3. The control apparatus according to claim 1,
wherein the first index value results from weighted averaging of the magnitudes of the differences between the coverages of the respective points included in the area and the first target value based on factor information indicating a weighted factor of each point included in the area.

4. The control apparatus according to claim 1,
wherein the second index value results from weighted averaging of the magnitudes of the differences between the capacities of the respective users using the communication service and the second target value based on factor information indicating a weighted factor of each user using the communication service.

5. The control apparatus according to claim 1,
wherein the controlling determines the operation state so as to improve the coverage or the capacity that is lower than its threshold value when at least either of the coverage and the capacity is lower than the threshold value, determines the operation state so as to decrease the difference between the first index value and the second index value when the result of the comparing indicates that the magnitude of the difference between the first index value and the second index value exceeds the given value after the coverage and the capacity are higher than or equal to the threshold value, and controls the operation state based on the result of the determination of the operation state.

6. The control apparatus according to claim 1,
wherein the controlling controls the operation state of the radio base station so as to decrease the difference between the coverage and the first target value when the magnitude of the difference between the first index value and the second index value exceeds the given value and the magnitude of the difference indicated by the first index value is greater than the magnitude of the difference indicated by the second index value.

7. The control apparatus according to claim 1,
wherein the controlling controls the operation state of the radio base station so as to decrease the difference between the capacity and the second target value when the magnitude of the difference between the first index value and the second index value exceeds the given value and the magnitude of the difference indicated by the second index value is greater than the magnitude of the difference indicated by the first index value.

8. The control apparatus according to claim 1,
wherein the controlling controls the operation state of the radio base station so as to increase the difference between the capacity and the second target value when the magnitude of the difference between the first index value and the second index value exceeds the given value and the magnitude of the difference indicated by the first index value is greater than the magnitude of the difference indicated by the second index value.

9. The control apparatus according to claim 1,
wherein the controlling controls the operation state of the radio base station so as to increase the difference between the coverage and the first target value when the magnitude of the difference between the first index value and the second index value exceeds the given value and the magnitude of the difference indicated by the second index value is greater than the magnitude of the difference indicated by the first index value.

10. A communication system comprising:
a radio base station;
a mobile terminal configured to be positioned in an area to which a communication service is provided by the radio base station and to establish radio communication with the radio base station; and
a control apparatus configured to compare a first index value indicating a magnitude of a difference between a coverage in the area and a first target value with a second index value indicating a magnitude of a difference between a capacity of the communication service in the area and a second target value and to control an operation state of the radio base station that varies at least one of the coverage and the capacity so as to decrease a difference between the first index value and the second index value when the result of the comparison indicates that the magnitude of the difference between the first index value and the second index value exceeds a given value.

11. A control method comprising:
comparing a first index value with a second index value, the first index value indicating a magnitude of a difference between a coverage in an area to which a communication service is provided by a radio base station to be controlled and a first target value, the second index value indicating a magnitude of a difference between a capacity of the communication service in the area and a second target value; and
controlling an operation state of the radio base station that varies at least one of the coverage and the capacity so as to decrease a difference between the first index value and the second index value when the result of the comparison between the first index value and the second index value indicates that the magnitude of the difference between the first index value and the second index value exceeds a given value.
